(19) United States
(12) Patent Application Publication
(10) Pub. No.: US 2006/0014640 A1
(43) Pub. Date: Jan. 19, 2006

(54) Paper, method for manufacturing the same, image-recording material support, and image-recording material

(75) Inventors: Yoshio Tani, Shizuoka (JP); Shigehisa Tamagawa, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 11/178,443

(22) Filed: Jul. 12, 2005

(30) Foreign Application Priority Data
Jul. 15, 2004 (JP) 2004-209084

(51) Int. Cl. B41M 5/035

(52) U.S. Cl. 503/227

(57) ABSTRACT

The object of the present invention is to provide a paper which has high surface planarity and excellent gloss and a method for manufacturing the paper, and moreover, to provide an image-recording material support and an image-recording material. For this object, the present invention provides a paper which comprises a raw paper and a polymer-containing layer on at least one surface of the raw paper to be formed with an image-recording layer and is prepared by subjecting a press and dry treatment.

### BACKGROUND OF THE INVENTION

1. Field of the Invention

The present invention relates to paper having high surface planarity and excellent gloss, a method for manufacturing the paper, an image-recording material support, and an image-recording material.

2. Description of the Related Art

Conventionally, paper that is efficiently machined at high speed is dried between many cylindrical driers by receiving a tension in the longitudinal direction (paper-making direction) while causing free shrinkage in the lateral direction. When being subjected to a change in humidity, the machined paper is likely to cause a large extension and/or shrinkage (telescopic motion) in the lateral direction. With this, recordings such as photographing with the above paper as a support may increase curl in size, thus high-quality image cannot be formed.

To solve the above problem, Japanese Patent Application Laid-Open UP-A) No. 01-292354 (equivalent of JP-B No. 2739160) discloses an electrophotographic transfer paper having a small shrinkage factor, an excellent surface planarity, and causing a small curl, even when the paper is subjected to a humidity change after drying. Specifically, the above electrophotographic transfer paper is machined with so-called a Yankee paper machine that can control drying shrinkage both in the longitudinal and lateral directions, without receiving a longitudinal tension during drying.

In this case, however, using the Yankee paper machine may generally restrict many paper-making conditions such as freeness of pulp paper material, paper-making speed, and the like.

On the other hand, a treatment in which a sheet of paper is dried while being pressurized (hereinafter may be referred to as press dry treatment) is expected to provide higher strength, elasticity modulus, density and the like, and such process is currently under development (Takuya Kadoya et al, “Science of paper-making” (Seishi Kagaku) (Tokyo: Chugai Sangyo Chosakai, pp. 174-177, Jun. 30, 1982 (Showa 57)). In addition, JP-A No. 2000-500536 and JP-A No. 07-91829 (JP-B No. 3041754) propose web pressure drying apparatuses which perform heat drying of a fiber web with a press dry treatment and provide less restrictions when used in a manufacturing line. In “Science of paper-making” (Seishi Kagaku), however, no specific conditions for press drying treatment and the like is disclosed. JP-A No. 2000-500536 and JP-A No. 07-91829 (JP-B No. 3041754) only disclose the press drying apparatuses, with no descriptions about relation between conditions for the press drying treatment and image-recording material support.

On the other hand, conventionally, raw paper, synthetic paper, a synthetic resin sheet, coat paper, laminate paper, and the like are well known for use as an image-recording material support. Among these image-recording material supports, coat paper and the laminate paper are preferred.

Methods of producing the coat paper and the laminate paper comprise a solvent coating method of applying to raw paper a thermoplastic resin which is solved in an organic solvent, an aqueous coating method of applying to raw paper a thermoplastic resin which is made into a latex or an aqueous solution (varnish), a dry laminate method of a thermoplastic resin, a melting extrusion coating method, and the like.

However, the above solvent coating method that uses a harmful organic solvent may cause harmful effect on the environment. In the above aqueous coating method, water may swell the raw paper when the latex or the aqueous solution (varnish) is applied to the raw paper, thus losing surface planarity (smoothness) of the raw paper, which is so called a “return.” Moreover, the aqueous coating method is not applicable to resins which are less likely to be made into latex or aqueous solution.

Summarizing the above, such an image-recording material support and an image-recording material are not proposed as having high surface planarity and extremely excellent gloss, leaving an issue of further improvement and development.

### SUMMARY OF THE INVENTION

It is therefore an object of the present invention to provide paper which has high surface planarity and excellent gloss and a method for manufacturing the paper. It is another object of the present invention to provide an image recording material support and an image recording material, both of which are suitably used for an electrophotographic material, heat sensitive material, inkjet-recording material, sublimation transfer material, silver salt photographic material, heat transfer material, and the like.

A paper according to the present invention comprises a raw paper, the raw paper comprises a polymer-containing layer on at least one surface with an image-recording layer disposed thereon, and the paper is subjected to a press dry treatment. The paper according to the present invention is capable of having high surface planarity and excellent gloss by subjecting a paper which is made from a raw paper having the polymer-containing layer to a press dry treatment and can be used preferably for various image-recording material supports.

According to the present invention, a method for manufacturing a paper comprises a polymer-containing layer forming step and a press dry treatment step. In the polymer-containing layer forming step, a polymer-containing layer is formed on at least one surface on a raw paper to be formed with an image recording layer. In the press dry treatment step, the raw paper with the polymer-containing layer formed thereon is subjected to a press dry treatment. As a result, a paper having high surface planarity and excellent gloss can be obtained.

According to the present invention, an image-recording material support comprises a paper according to the present invention. An image-recording material according to the present invention comprises an image-recording material support of the present invention and an image-recording layer on the image-recording material support. The image-recording material according to the present invention having high surface planarity and excellent gloss can be used preferably as at least any one of recording materials selected from an electrophotographic material (electrophotographic image-receiving material), a heat sensitive material (heat sensitive coloring recording material), a sublimation transfer material (sublimation transfer image-receiving material), a silver salt photographic photosensitive material, and a heat transfer material (heat transfer image-receiving material).

### BRIEF DESCRIPTION OF THE DRAWINGS

FIG. 1 is a schematic view showing an example of a press dry treatment apparatus according to the present invention.

FIG. 2 is a schematic view showing an example of a press dry treatment apparatus used for a production line according to the present invention.

FIG. 3 is a block diagram schematically showing a fixing belt apparatus of an image forming apparatus used for examples according to the present invention.

### DESCRIPTION OF THE PREFERRED EMBODIMENTS

(Paper)

A paper according to the present invention comprises a raw paper which comprises a polymer-containing layer at least on one surface with an image recording layer disposed thereon and further comprises other layers when necessary.

According to the present invention, for the raw paper, a raw paper made from a press-dry-treated wet paper is used.

Raw Paper

The raw paper is not particularly limited and may be selected in accordance with the intended use. Specifically, the raw paper may be preferred to be a high-quality paper, like those described on page 223 to page 224 of “Fundamentals of Photography (shashin kougaku no kiso)—Silver Salt Photograph”—Society of Photographic Science and Technology of Japan published by Corona, 1979 (Showa 54).

As long as being a known material used for the image-recording material support, the raw paper is not particularly limited, and may be selected in accordance with the intended use. Examples of the raw paper include natural pulps such as needle-leaf tree pulp, broad-leaf tree pulp and the like, a mixture of the above natural pulp(s) with a synthetic pulp(s), and the like.

The pulp usable for a raw material of the raw paper is preferred to be a broad-leaf tree bleached kraft pulp (LBKP), from the view point of simultaneously improving surface planarity, rigidity, and dimension stability (curling property) of the raw paper, in a good balance and to a sufficient level. A needle-leaf tree bleached kraft pulp (LBKP) and a broad-leaf tree sulfite pulp (LBSP) and the like are, however, also usable.

A beater, a refiner or the like can be used for beating the pulp. The pulp is preferably beaten to a Canadian Standard Freeness (C.S.F.) of 200 ml C.S.F. to 440 ml C.S.F. and is more preferably beaten to 250 ml C.S.F. to 380 ml C.S.F., since paper shrinkage can be controlled in paper-making process.

When necessary, various types of additives can be added to a pulp slurry (hereinafter referred to as “pulp paper material” as the case may be) which can be obtained after beating the pulp. Examples of the additives include filling materials, dry paper reinforcers, sizing agents, wet paper reinforcers, fixing agents, pH regulators, and other agents.

Examples of the filling material include calcium carbonate, clay, kaolin, white clay, talc, titanium oxide, diatomaceous earth, barium sulfate, aluminum hydroxide, magnesium hydroxide.

Examples of the dry paper reinforcers include cationic starch, cationic polyacrylamide, anionic polyacrylamide, amphoteric polyacrylamide, carboxy-modified polyvinyl alcohol.

Examples of the sizing agents include a rosin derivative such as fatty acid salt, rosin, maleic rosin; paraffin wax, alkyl ketene dimer, alkenyl succinic anhydride (ASA); and a compound containing higher fatty acid such as epoxy aliphatic amide.

Examples of the wet paper reinforcers include polyamine polyamide epichlorohydrin, a melamine resin, a urea resin, and an epoxy polyamide resin.

Examples of the fixing agents include a polyvalent metallic salt such as aluminum sulfate, aluminum chloride; and a cationic polymer such as cationic starch.

Examples of the pH regulators include caustic soda, and sodium carbonate.

Examples of other agents include a defoaming agent, a dye, a slime control agent, a fluorescent whitening agent.

Moreover, a softener may also be added when necessary. For the softener, for example, those disclosed on pp. 554-555 of “Paper and Paper Treatment Manual” (Shiyaku Time Co., Ltd.), 1980 and the like can be used.

Each of the above additives and the like may be used alone or in combination of two or more. The amount of each of the additives into the pulp paper material is not particularly limited and may be suitably selected in accordance with the intended use, and typically, 0.1% by mass to 1.0% by mass is preferred.

The pulp paper material which is the pulp slurry to which the various types of additives are added as required is to be machined by using a paper-making machine such as a manual paper-making machine, a long-net paper-making machine, a round-net paper-making machine, a twin-wire machine, a combination machine, and thereafter is dried for preparing the raw paper. When necessary either before and after the drying, a surface sizing treatment may be carried out.

Surface sizing treatment liquids used for the surface sizing treatment is not particularly limited and may be suitably selected in accordance with the intended use. For example, the surface sizing treatment liquids may include a water-soluble high molecular compound, a waterproof substance, a pigment, a dye, and a fluorescent whitening agent.

Examples of the water-soluble high molecular compounds include cationic starch, polyvinyl alcohol, carboxy-modified polyvinyl alcohol, carboxymethyl cellulose, hydroxymethyl cellulose, cellulose sulfate, gelatin, casein, sodium polyacrylate, styrene-maleic acid anhydride copolymer sodium salt, and sodium polystyrene sulfonate.

Examples of the waterproof substances include latex emulsions such as styrene-butadiene copolymer, ethylene-vinyl acetate copolymer, polyethylene, and vinylidene chloride copolymer; and polyamide polyamine epichlorohydrin.

Examples of the pigments include calcium carbonate, clay, kaolin, talc, barium sulfate, and a titanium oxide.

As for the above-mentioned raw paper, to improve the rigidity (stiffness) and dimension stability (curling property) of the image-recording material support, it is preferred that the ratio (Ea/Eb) of the longitudinal Young's modulus (Ea) to the lateral Young's modulus (Eb) is within a range from 1.5 to 2.0. When the ratio (Ea/Eb) is less than 1.5 or more than 2.0, the rigidity (stiffness) and curling property of the image-recording material support tend to deteriorate and may cause inconveniences to traveling property during transportation.

It has been found that, in general, the “rigidity (stiffness)” of the paper differs based on differences in the way the paper is beaten, and the elasticity modulus of paper from paper-making after beating can be used as an important indicator of the “rigidity (stiffness)” of the paper. The elasticity modulus of the paper can be calculated from the following equation by using the relation of the density and the dynamic modulus which shows the physical properties of a viscoelastic object, and by measuring the velocity of sound propagation in the paper using an ultrasonic oscillator.
E=ρc²(1−n²)

Where “E” represents dynamic modulus; “p” represents density; “c” represents the velocity of sound in paper; and “n” represents Poisson's ratio.

As n=0.2 or so in a case of ordinary paper, there is not much difference in the calculation, even when the calculation is performed by the following equation:
E=ρc²

Accordingly, when the density of the paper and acoustic velocity can be measured, the elasticity modulus can be easily calculated. In the above equation, when measuring acoustic velocity, various instruments known in the art may be used such as Sonic Tester SST-110 (Nomura Shoji Co., Ltd.) or the like.

To give a desired average paper centerline roughness to the surface of the raw paper, for instance, it is preferable to use pulp fiber having a fiber length distribution (for example, pulp fiber having a total residue of the residue in a 24 mesh screen and the residue in a 42 mesh screen being 20% by mass to 45% by mass, and the residue in the 24 mesh screen being 5% by mass or less) as described in Patent Application Laid-Open (JP-A) No. 58-68037. It is also possible to control the average paper centerline roughness by adding heat and pressure using a machine calendar, a super calendar and the like to provide surface treatment.

The thickness of the raw paper is not particularly limited, and may be suitably selected in accordance with the intended use, and it is preferably 30 μm to 500 μm, more preferably 50 μm to 300 μm, and still more preferably 100 μm to 250 μm. The basis weight of the raw paper is not particularly limited and may be suitably selected in accordance with the intended use, and for example, it is preferably from 50 g/m² to 250 g/m², and more preferably from 100 g/m² to 200 g/m².

Polymer-Containing Layer

The polymer-containing layer is formed at least on a face of the raw paper with an image recording layer formed thereon. The polymer-containing layer comprises any one of a water-soluble polymer and a water-dispersible polymer emulsion and may further comprise pigments and other components as required.

Examples of the water-soluble polymer include cationic starch, polyvinyl alcohol, carboxy-modified polyvinyl alcohol, carboxy-methyl cellulose, hydroxyl-ethyl cellulose, cellulose sulfate, gelatin, casein, sodium polyacrylate, sodium salt of styrene maleic acid anhydride copolymer, and sodium polystyrene sulfonate. Each of these water-soluble polymers may be used alone or in combination of two or more.

As for the water-dispersible polymer emulsion, any one of emulsions and latexes are suitably used. Examples of the emulsion include hydrocarbon waxes such as paraffin wax, and microcrystalline wax; oxygen-containing waxes such as carnauba wax, and montan wax-oxidized paraffin; hydrocarbon resins such as petroleum wax, coumarone-indene resin, terpene resin, and carboxylic acid adducts; polyolefins such as polyethylene, polypropylene; various emulsions such as acrylate, acrylate-styrene, and polyester; and other emulsions such as alkyl-ketone dimer emulsions, and epoxidized fatty acid amide emulsions. Each of these water-dispersible polymer emulsions may be used alone or in combination of two or more. Among these emulsions, soap-free emulsions are particularly preferable.

As for the soap-free emulsions, any one of acrylic soap-free emulsions and polyolefin soap-free emulsions are preferably used.

Examples of the acrylic soap-free emulsions include acrylic ester monopolymer, and a copolymer of acrylic esters with methacrylic acid ester, vinyl acetate, styrene, acrylonitrile, and acrylic acid. Examples of the polyolefin soap-free emulsions include ethylene-vinyl acetate copolymer emulsions, ethylene-acrylic acid copolymer emulsions, and ionomer emulsions.

As for the aqueous medium, the one that is based on water or the one with a water-soluble organic solvent added to water is preferably used. Examples of the water soluble organic solvents include ethylene glycol, propylene glycol, butylene glycol, diethylene glycol, triethylene glycol, polyethylene glycol (average molecular weight being about 190 to 400), glycerin, alkyl ethers of the above-mentioned glycols, N-methylpyrrolidone, 1,3-dimethyl imidazolinon, thiodiglycol, 2-pyrrolidone, sulfolane, dimethyl sulfoxide, diethanolamine, triethanolamine, ethanol, and isopropanol.

To the soap-free emulsion coating solutions, the following various additives may be arbitrarily applied where necessary: such as matting agents, pigments, plasticizers, releasing agents, lubricants, thickeners, antistatic additives, fluorescent whitening agents, and color tone adjustor dyes.

Examples of the latexes include various types of latexes, SBR, MBR, and PVdc. Among these latexes, soap-free latexes are particularly preferable. As for the soap-free latexes, core/shell latex particles obtained by an emulsion polymerization method without any uses of emulsifying agents (surfactants) are preferably used. (For example, pp. 279-281 of “Synthesis/Design of Acrylic Resin and Development of New Applications” published by Chubu Keiei Kaihatsu Center on Jul. 1, 1985.

Examples of methods for manufacturing the soap-free latexes include seed method, reactive emulsifying agent, and oligomer method.

The seed method is a method in which a water-dispersible polymer is preliminarily prepared as a seed polymer and then polymerized by adding a monomer.

In the seed method, typically, the core portion is formed from a seed polymer, and the shell portion is formed from a polymer which is polymerized according to polymerization of a monomer to form a core/shell structure.

The reactive emulsifying agent method is a method in which a compound having ethylene-unsaturated bond and anionic or nonionic hydrophilic group in a molecule (a reactive emulsifying agent) is used in the same manner as conventional emulsifying agents. A reactive emulsifying agent to be used will be, however, introduced into a polymer to be formed and will never remain as the emulsifying agent.

As the reactive emulsifying agent, various reactive emulsifying agents are known in the art such as acrylic acid derivatives (described in JP-A Nos. 55-11252, 56-28208, and the like); itaconic acid derivatives (described in JP-A No. 51-30284, and the like); maleic acid derivatives (described in JP-A No. 51-30284 and JP-B No. 56-29657); fumaric acid derivatives (described in JP-A Nos. 51-30285, 51-30284, and the like).

Specifically, as suitable seed polymers for manufacturing the core/shell latex resin composition, it is possible to use seed polymers prepared by any one of an emulsion polymerization method, a suspension polymerization method, and dispersion polymerization method. Among these methods, it is proper to use a seed polymer prepared by an emulsion polymerization method. Even when an emulsifying agent is used in the emulsion polymerization method, the amount of emulsifying agent can be substantially reduced in the separation and refinement step. Even when a small amount of emulsifying agent is included in the seed polymer, the seed polymer is unlikely to be affected by moisture because the seed polymer is taken into the core/shell structure and never exist on the surface of the seed polymer. Seed polymers prepared by a suspension polymerization or a dispersion polymerization will need troublesome steps for removing dispersants, solvents, and the like.

As for the seed polymers, specifically, water-soluble high molecular materials are suitably used. For instance, as the water-soluble high molecular materials, it is possible to use polyacrylic acid salt or a copolymer thereof, gelatin, tragacanth gum, starch, methyl cellulose, hydroxymethyl cellulose, carboxymethyl cellulose, polyvinyl alcohol, and polyvinyl pyrrolidone.

As the monomer to be added in the presence of the seed polymer in the seed method, various ethylene unsaturated monomers can be used, provided that radical polymerization is possible with an ethylene unsaturated monomer. In this case, the monomer may be same as or different from the monomer used for manufacturing the seed polymer.

Examples of the suitable monomers include (meth)acrylic acid ester monoders, monovinyl aromatic monomers, (metha) vinyl ester monomers, vinyl ether monomers, monoolefin monomers, diolefin monomers, halogenated olefin monomers, and polyvinyl monomers.

Examples of the (meth)acrylic acid monomers include (meth)acrylic acid, methyl (meth)acrylate, ethyl (meth)acrylate, butyl (meth)acrylate, (meth) acrylic acid-2-ethylhexyl, cyclohexyl (meth)acrylate, phenyl (meth)acrylate, β-hydroxyethyl acrylate, γ-propylamino acrylate, stearyl methacrylate, dimethylaminoethyl methacrylate, diethylaminoethyl or a mixture thereof.

Examples of the vinyl aromatic monomers include styrene monomers such as styrene, o-methylstyrene, m-methylstyrene, p-methylstyrene, p-methoxystyrene, p-phenylstyrene, p-chlorostyrene, p-ethylstyrene, p-butylstyrene, p-t-butylstyrene, p-hexylstyrene, p-octylstyrene, p-nonylstyrene, p-decylstyrene, p-dodecylstyrene, 2,4-dimethylstyrene, 3,4-dichlorstyrene or a derivative thereof or a mixture thereof.

Examples of the vinyl ester monomers include vinyl acetate, vinyl propionate and vinyl benzoic acid.

Examples of the vinyl ether monomers include vinyl methyl ether, vinyl ethyl ether, vinyl isobutyl ether, and vinyl phenyl ether.

Examples of the olefin monomers include monoolefin monomers such as ethylene, propylene, isobutylene, 1-butene, 1-pentene, and 4-methyl-1-pentene; and diolefine monomers such as butadiene, isoprene, and chloroprene.

Further, cross-linking monomers may be added to improve properties of seed polymers. Examples of the cross-linking monomers include a monomer having two or more unsaturated bonds such as divinylbenzene, divinyl naphthalene, divinyl ether, diethylene glycol methacrylate, ethylene glycol dimethacrylate, polyethylene glycol dimetahcrylate, and diallyl phthalate.

In the seed method, it is possible to use a radical polymerization initiator. The radical polymerization initiator is arbitrarily usable as long as the initiator is water-soluble. Examples of such preferred radical polymerization initiators include persulfate (such as potassium persulfate, and ammonium persulfate); an azo compound (such as 4,4′-azobis 4-cyanovaleric acid or salts thereof, and 2,2′-azobis (2-amidinopropane) salts); and per oxide compounds.

Further, where necessary, the polymerization initiators may be combined with a reducing agent to use as redox initiators. Using the redox initiator enables improving polymerization activity and reducing polymerization temperature and makes it possible to expect shortening polymerization time.

The polymerization temperature may be selected from any temperatures, provided that the polymerization temperature is equal to or greater than the minimum radical forming temperature of the polymerization initiator, and for example, typically, a temperature from 50° C. to 80° C. is used. However, it is also possible to perform polymerization at room temperature or lower than room temperature by using a combination of polymerization initiators initiating from room temperature, for instance, using a combination of hydrogen peroxide and a reducing agent (such as ascorbic acid).

In the core/shell latex particles, the number average molecular weight of core [(Mn (c)] is preferably 30,000 to 500,000 and more preferably 40,000 to 400,000.

On the other hand, the number average molecular weight of shell [(Mn (s)] is preferably 4,000 to 30,000 and more preferably 5,000 to 20,000.

In the core/shell latex particles, a mass ratio of the core to the shell is preferably 10:90 to 90:10, and more preferably 20:80 to 80:20. When the ratio of core to shell is larger than or smaller than the above mentioned range (10:90 to 90:10), it becomes difficult to sufficiently bring out characteristics of core/shell structure and becomes closer to characteristics of a mere consecutive layer.

The average particle diameter of the core/shell latex particles is preferably 0.2 μm or less, and more preferably 0.1 μm or less. The lower limit of the average particle diameter is, for example, 0.04 μm or so. When the average particle diameter of the core/shell latex particles is more than 0.21 μm, it is impossible to make full use of the characteristics of core/shell structure.

To the soap-free latex coating solution, the following various additives may be arbitrarily applied where necessary: such as matting agent, pigment, plasticizer, releasing agent, lubricant, thickener, antistatic additive, fluorescent whitening agent, and color tone adjustor dye.

The glass transition temperature (Tg) of the resin in any of the soap-free latex and the soap-free emulsion is preferably 30° C. or more, and more preferably 50° C. or more.

It is preferred that the polymer-containing aqueous coating solution comprises a pigment(s). Examples of the pigments include titanium dioxide, calcium carbonate, clay, kaolin, talc, barium sulfate, and silica.

The polymer-containing aqueous coating solution is coated, for example, with a blade coater, an air-knife coater, a roll coater, a comma coater, a brush coater, a squeeze coater, curtain coater, a kiss coater, a bar coater, and a gravure coater, and a blade coating method is particularly preferable.

The application quantity or the impregnated amount of the polymer-containing aqueous coating solution to the raw paper is preferably 0.5 g/m² to 30 g/m², and more preferably 1 g/m² to 15 g/m².

Press Dry Treatment

The press dry treatment is not particularly limited and may be suitably selected in accordance with the intended use, provided that it can heat and dry the pulp paper material while pressing it to soften paper fibers and allow the fibers to come close to each other. For example, the pulp paper material is dehydrated using a manual paper-making machine and then its water content before press dry treatment is adjusted to 5% to 30% using a wet press apparatus or the like, thereby forming a sheet of raw paper. Then a press dry treatment is performed at a drying temperature of 100° C. to 200° C. on the raw paper, specifically, on a side (of the raw paper whose water content is adjusted) to be formed with an image-recording layer.

The water content of the polymer-containing layer before the press dry treatment is preferably 5% to 30%, more preferably 7% to 15% in order for preventing crush of the polymer-containing layer.

The water content of the polymer-containing layer after the press dry treatment is not particularly limited and may be suitably selected in accordance with the intended use, preferably it is 10% or less, and more preferably 3% to 8%.

The drying temperature on the side of the raw paper to be formed with the image-recording layer is preferably from 100° C. to 200° C., and more preferably 110° C. to 180° C. When the drying temperature is lower than 100° C., a sufficient amount of water does not evaporate and binding among fibers becomes weak, which sometimes results in unfavorable paper force. When it is higher than 200° C., sizing property and surface planarity may become insufficient due to the relationship with additives.

The pressure of the press dry treatment is preferably from 0.05 MPa to 0.5 MPa. When the pressure of the press dry treatment is less than 0.05 MPa, there may be cases where the surface planarity becomes insufficient due to reduced fluidity of fibers, while more than 0.5 MPa, it may cause unfavorable adhesion with a coating layer.

The density of the raw paper after the press dry treatment is preferably 0.8 g/cm³ or more, and more preferably 0.9 g/cm³ or more. When the density of the raw paper is less than 0.8 g/cm³, there may be cases where sufficient surface planarity cannot be obtained.

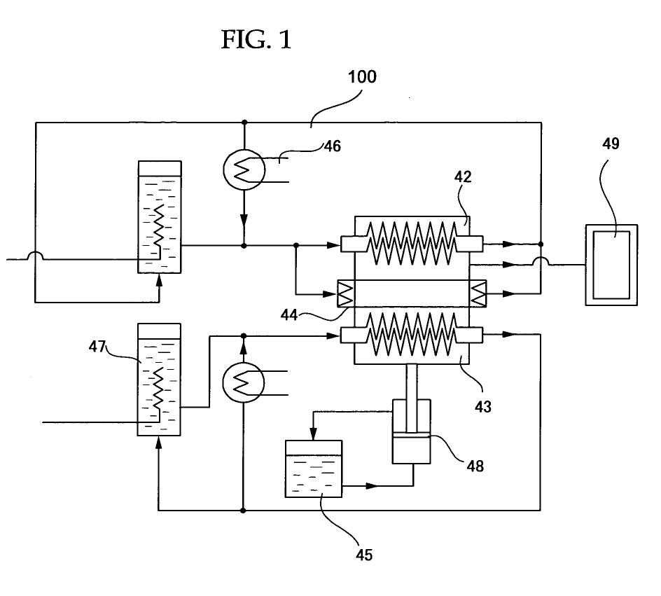

The apparatus with which the press dry treatment is performed is not particularly limited and may be suitably selected in accordance with the intended use. For example, a press dry treatment apparatus 100 based on Condebelt drying technique as shown FIG. 1 is preferable as an apparatus which is not incorporated in a production line and is oriented toward laboratory use.

The press and dry treatment apparatus 100 comprises an upper plate 42, a lower plate 43, a jacket 44 provided between the upper plate 42 and the lower plate 43, and other members when necessary.

Drying with the press dry treatment apparatus 100 is performed by placing a sheet of wet paper (not shown) which has been prepared by dehydrating pulp paper material with a manual paper-making machine and a wet press apparatus or the like in the jacket 44 which is impermeable to air and by thermally drying and pressuring the sheet with the upper plate 42 and the lower plate 43 each of which temperature is controlled by electrically heated oil 47. During pressure and drying, water vapor and the like which are generated from the wet paper are removed by a vacuum tank 49. Pressuring is performed by applying pressure to the lower plate 43 with a pressing unit 48 using hydraulic oil 45. Further, during pressure and drying, cooling water 46 is configured to flow through the apparatus.

For example, “Static Condebelt” (manufactured by VALMET Corp.) which is a static press dry equipment may be used as one of such press dry treatment apparatuses.

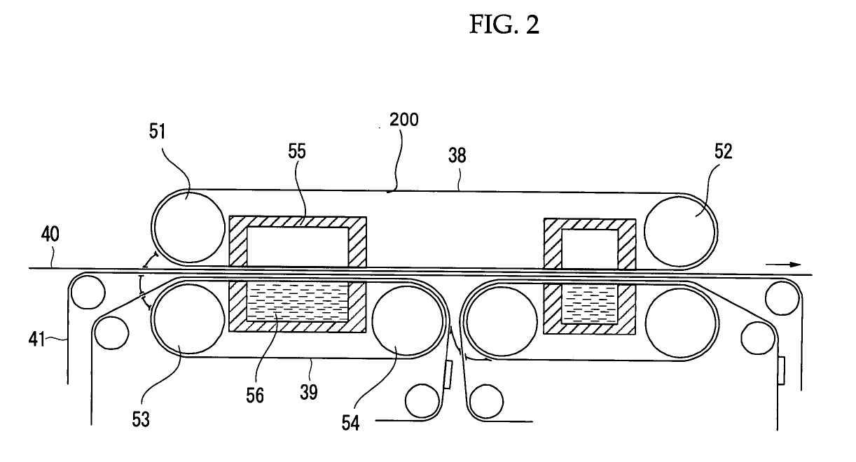

On the other hand, when the press dry treatment is to be incorporated into a production line so that it can be performed continuously, a press dry treatment apparatus 200 as shown in FIG. 2 is preferable.

Referring to FIG. 2, the press dry treatment apparatus 200 comprises a first endless belt 38 and a second endless belt 39 which are impermeable to air and conduct heat efficiently, a fist set of turning rollers 51 and 52 around which the first endless belt 38 is arranged to turn, and a second set of turning rollers 53 and 54 around which the second endless belt 39 is arranged to turn.

The first endless belt 38 and the second endless belt 39 are arranged in such a way that they run part of the way parallel with each other so that they form a drying zone between themselves.

A heating chamber 55 heats the first endless belt 38, and a cooling chamber 56 cools the second endless belt 39.

Then, dehydrated wet paper 40 and at least one fabric 41 which forms an endless loop are introduced between the first endless belt 38 and the second endless belt 39 in such a way that the dehydrated wet paper 40 is in contact with the heated first endless belt 38 and the fabric 41 is positioned between the dehydrated wet paper 40 and both of the cooled second endless belt 39 and guide rollers for guiding an endless fabric and accordingly the wet paper is pressed and dried.

The details of the press dry treatment apparatus 200 are described in JP-A No. 2000-500536.

According to the press dry treatment apparatus, it is possible to achieve a good press dry result more efficiently than with conventional ones.

By the press dry treatment described above, the sheet of raw paper has better density, elasticity modulus, tensile strength, strength and the like so as to provide an image-recording material support which is excellent in dimension stability and surface planarity and with which curl is less likely to occur. Accordingly, by using the above image-recording material support, it is possible to provide high-quality images.

The image-recording material support according to the present invention comprises the paper according to the present invention. The paper comprises a raw paper and a polymer-containing layer at least on a side of the raw paper to be formed with an image-recording layer and is subjected to a press dry treatment, to thereby form a paper which particularly excels in surface planarity and has excellent gloss.

The average center surface roughness (SRa) of a surface on the side to be formed with an image-recording layer in the image-recording material support measured at a wavelength of 5 mm to 6 mm is preferably 0.5 μm or less, and more preferably from 0.1 μm to 0.4 μm. When the average center surface roughness (Sra) is more than 0.5 μm, the surface planarity after coating may become insufficient.

Here, the average center surface roughness (SRa) can be obtained by scanning three-dimensionally a plane having a certain roughness, and therefore is different from an average center line roughness (Ra) that can be obtained by scanning a linear roughness of a plane. The average center surface roughness (SRa) can be measured at a cutoff wavelength of 5 mm to 6 mm, by using SURFCOM 570A-3DF (manufactured by TOKYO SEIMITSU CO., LTD.), based on the following measuring and analyzing conditions.

Measuring and Analyzing Conditions

Scanning direction: MD direction of sample
Measuring length: Machining paper direction (X-direction) 50 mm, and perpendicular direction (Y-direction) thereto 30 mm.
Measuring pitch: X-direction 0.1 mm, Y-direction 0.1 mm
Scanning speed: 30 mm/sec.
Band pass filter: 5 mm to 6 mm

In terms of surface planarity and gloss of the image-recording material support, 20% or more at 20-degree gloss is preferable, and 40% or more at 20-degree gloss is more preferable. The gloss less than 20% may cause an insufficient gloss after the image formation.

The above-mentioned 20-degree gloss can be measured based on JIS Z8741.

In terms of waterproof of the image-recording material support, specifically, Cobb sizing water absorbency is preferred to be 10 g/m² or less in 30 seconds, more preferably 5 g/m² or less, and still more preferably 4 g/m² or less.

The above-mentioned Cobb sizing water absorbency can be obtained by measuring the amount of water absorbency when a pure water has a contact with a sample for 120 seconds pursuant to JIS P8140.

(Method for Manufacturing Paper)

A method for manufacturing paper according to the present invention comprises a polymer-containing layer forming step and a press dry treatment step, and other steps when necessary.

The polymer-containing layer forming step is a step in which at lease any one of coating and impregnation of a polymer-containing coating solution is performed at least on the side of a raw paper to be formed with an image-recording layer and then to form a polymer-containing layer.

In this case, it is preferred that the polymer-containing layer forming step is performed to a raw paper which is prepared by subjecting a wet paper to a press dry treatment.

The method for coating the polymer-containing coating solution is not particularly limited and may be suitably selected in accordance with the intended use. Examples of the coating method include a blade coating method, an air-knife coating method, a gravure coating method, a roll coating method, a spray coating method, a dipping coating method, a bar coating method, an extrusion coating method, and a spin coating method.

The press dry treatment step is a step for drying and applying pressure to a raw paper on which a polymer-containing layer is preliminarily formed.

In this case, the raw paper is preferred to be dried until the water content of the polymer-containing layer becomes 5% to 30% before the press dry treatment.

The raw paper prepared by drying and applying pressure to a wet paper is preferred to be subjected to a calender treatment because excellent surface planarity and gloss can be obtained.

The calender treatment is not particularly limited and may be suitably selected in accordance with the intended use. In this case, however, a high temperature soft calender treatment is preferred, and temperature of the surface of the metal roll is preferably 110° C. or more, more preferably 150° C. or more, and still more preferably 250° C. or more. An upper limit of the temperature is, for example, 300° C.

Carrying out the press dry treatment before binding the polymer-containing layer is preferred in terms of further improvements in its surface planarity and gloss.

The paper according to the present invention which can be obtained through the above processes has high surface planarity and excellent gloss and can be used for various applications. Particularly, the paper is preferably to be used for as an image-recording material support.

(Image-Recording Material)

According to the present invention, an image recording material comprises a support and an image-recording layer formed on the support, and the support is the image-recording material support according to the present invention.

The image-recording material varies depending on the intended use and the type thereof, and examples thereof include electrophotographic materials, heat sensitive materials, inkjet-recording materials, sublimation transfer materials, silver salt photographic materials, and heat transfer materials.

<Electrophotographic Material>

The electrophotographic material includes an image-recording material support and at least one toner image-receiving layer which is disposed at least on one surface of the support according to the present invention. When necessary, the electrophotographic material may further include other layers which may be suitably selected. Examples of the other layers include a surface protection layer, an intermediate layer, a back layer, an underlayer, a cushion layer, a static control (prevention) layer, a reflection layer, a color tone adjusting layer, a storage property improvement layer, an anti-stick layer, an anti-curl layer, and a smoothing layer. Each of these layers may have a single-layer structure or a laminated structure.

[Toner Image-Receiving Layer]

The toner image-receiving layer receives a color toner or a black toner and forms an image. The toner image-receiving layer serves to receive toner which forms an image from a developing drum or an intermediate transfer by (static) electricity or pressure in a transferring step and servers to fix the image by heat, pressure or the like in a fixing step.

From the viewpoint of making an electrophotographic material according to the present invention have hand-touch close to a photograph, a toner image-receiving layer having a low light transmittance of 78% or less is preferable. The light transmittance is more preferably 73% or less, and still more preferably 72% or less.

The light transmittance can be measured by preliminarily forming a coating layer having a thickness of 100 μm on a polyethylene terephthalate film which has the same thickness as that of the coating layer and by measuring the coating layer using a direct reading hazemeter (HGM-2DP, manufactured by SUGA TEST INSTRUMENTS CO., Ltd.).

The toner image-receiving layer comprises a thermoplastic resin and where necessary, may comprise various additives to be added for improving thermodynamic properties of the toner image-receiving layer. Examples of the additives include releasing agents, plasticizers, colorants, fillers, cross-linking agents, charge control agents, emulsifiers, and dispersants.

Thermoplastic Resin

The thermoplastic resin is not particularly limited and may be suitably selected in accordance with the intended use. Examples of the thermoplastic resin include (1) polyolefin resins, (2) polystyrene resins, (3) acrylic resins, (4) polyvinyl acetate or a derivative thereof, (5) polyamide resins, (6) polyester resins, (7) polycarbonate resins, (8) polyether resins (or acetal resins), and (9) other resins. Each of these resins may be used alone and in combination of two or more. Among the above resins, in terms of embedding of the toner, preferably used are styrene resins, acrylate resins, and polyester resins which have high coagulation energy.

Examples of (1) polyolefin resins include polyolefin resins such as polyethylene, and polypropylene; and copolymer resins of olefins (such as ethylene, and propylene) with other vinyl monomers. Examples of the copolymer resins of olefins with other vinyl monomers include ethylene-vinyl acetate copolymer, and an ionomer resin which is a copolymer of olefins with acrylic acid or methacrylic acid. Herein, examples of the derivatives of polyolefin resins include chlorinated polyethylene, and chlorosulfonated polyethylene.

Examples of (2) polystyrene resins include polystyrene resins, styrene-isobutylene copolymer, acrylonitrile-styrene copolymer (AS resin), acrylonitrile-butadiene-styrene copolymer (ABS resin), and polystyrene-maleic anhydride resins.

Examples of (3) acrylic resins include polyacrylic acid or esters thereof, polymethacrylic acid or esters thereof, polyacrylonitrile, and polyacrylamide.

Examples of the esters of polyacrylic acid include homopolymer or polytypic copolymer of acrylic acid. Examples of esters of acrylic acid include methyl acrylate, ethyl acrylate, n-butyl acrylate, isobutyl acrylate, dodecyl acrylate, n-octyl acrylate, 2-ethylhexyl acrylate, 2-chloroethyl acrylate, phenyl acrylate, and α-methyl chloroacrylate.

Examples of esters of polymethacrylic acid include homopolymer or polytypic copolymer of methacrylic acid. Examples of esters of methacrylic acid include methyl methacrylate, ethyl methacrylate, and butyl methacrylate.

Examples of (4) polyvinyl acetates or derivatives thereof include polyvinyl acetate and polyvinyl alcohol which is obtained by saponifying polyvinyl acetate, polyvinyl acetal resins obtained by reacting polyvinyl alcohols with aldehydes (such as formaldehyde, acetaldehyde, and butylaldehyde).

Examples of (5) polyamide resins include polycondensation of diamine with dibasic acid such as 6-nylon, and 6,6-nylon.

Polyester resins (6) are produced by polycondensation of acid composition with alcohol composition. The acid composition is not particularly limited and may be suitably selected in accordance with the intended use. Examples of the acid composition include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenyl succinate, isododecenyl succinate, n-dodecyl succinate, isododecyl succinate, n-octenyl succinate, n-octyl succinate, isooctenyl succinate, isooctyl succinate, trimellitic acid, pyromellitic acid, acid anhydrides thereof, and low alkyl esters thereof.

The alcohol composition is not particularly limited and may be suitably selected in accordance with the intended use. Diatomic alcohol is preferable. Examples of fatty series diols include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol. Examples of alkylene oxide adducts of bisphenol A include polyoxypropylene, (2.2)-2,2-bis (4-hydroxyphenyl) propane, polyoxypropylene (3.3)-2,2-bis (4-hydroxyphenyl) propane, polyoxyethylene (2.0)-2,2-bis (4-hydroxyphenyl) propane, polyoxypropylene (2.0)-polyoxyethylene (2.0)-2,2-bis (4-hydroxyphenyl) propane, and polyoxypropylene (6)-2,2-bis (4-hydroxyphenyl) propane.

A general example of (7) polycarbonate resin is polycarbonate ester which is obtained from bisphenol A and phosgene.

Examples of (8) polyether resins (or acetal resin) include polyether resins such as polyethylene oxides, and polypropylene oxides; and acetal resins such as polyoxymethylene as ring-opening polymerization.

Examples of other resins (9) include polyurethane resins of polyaddition.

As the thermoplastic resin for the toner image-receiving layer, those satisfying toner image-receiving layer properties (to be described afterward) are preferable in a state where the toner image-receiving layer is formed. Those satisfying the above-noted properties alone are more preferable. Use of two or more resins with different toner image-receiving layer properties (to be described afterward) is also preferable.

As the thermoplastic resin for the toner image-receiving layer, those having greater molecular weight are preferable than the thermoplastic resin used for the toner. The relative molecular weight is, however, not necessarily limited to the relation of the molecular weight, in view of thermodynamic properties of the thermoplastic resin used for the toner relative to the thermoplastic resin used for the toner-image receiving layer. For instance, when the thermoplastic resin used for the toner image-receiving layer is higher in terms of softening temperature than the thermoplastic resin used for the toner, preferably, these molecular weights are equal or as the case may be the thermoplastic resin used for the toner image-receiving layer has smaller molecular weight.

As the thermoplastic resin for the toner image-receiving layer, it is preferable to use a mixture of resins which have the same composition and have different average molecular weights from each other. Japanese Patent Application Laid-Open (JP-A) No. 08-334915 discloses a preferable relation, in terms of molecular weight, between the thermoplastic resin for the toner image-receiving layer and the thermoplastic resin used for the toner.

In terms of distribution of molecular weight, the thermoplastic resin for the toner image-receiving layer is wider than the thermoplastic resin used for the toner.

Preferably, the thermoplastic resins for the toner image-receiving layer has properties disclosed in JP-A Nos. 05-127413, 08-194394, 08-334915, 08-334916,09-171265, and 10-221877.

As the thermoplastic resin for the toner image-receiving layer, aqueous resins such as water-dispersible polymers and water-soluble polymers are preferably used for the following reasons:
(i) an aqueous resin is excellent in environmental properties and workability since no organic solvent is discharged at coating-drying step.
(ii) Many releasing agents such as wax are unlikely to be solved in solvent at room temperature, and are often dispersed, prior to usage, in solvent (water and organic solvent). Water dispersing form is more stable and is more adaptive to production steps. Moreover, an aqueous coating is more likely to cause bleeding of wax on the surface in the process of coating-drying, thus making it easier to obtain the effect of the releasing agent (antioffset property, adhesion resistance, and the like).

The aqueous resins, provided that they are either a water-dispersible polymer or a water-soluble polymer, are not particularly limited as to composition, bonding structure, molecular structure, molecular weight, molecular weight distribution, form, and the like, and may be suitably selected in accordance with the intended use. Examples of aqueous group of the above polymers include sulfonic group, hydroxyl group, carboxylic group, amino group, amide group, and ether group.

The above water-dispersible polymers may be made, for example, by suitably selecting from the following and combining two or more of them: i) resins made by dispersing in water the thermoplastic resins for toner image-receiving layer numbered by (1) to (9) above, ii) emulsions made by dispersing in water the thermoplastic resins for toner image-receiving layer numbered by (1) to (9) above, iii) copolymer thereof, iv) mixture thereof, and v) cationic modified product.

The water-dispersible polymer may be suitably synthesized for use, or those commercially available are usable. Examples of commercial products of the water-dispersible polymers include polyester resins such as Vylonal series by Toyobo Co., Ltd., Pesresin A series by Takamatsu Oil & Fat Co., Ltd., Tuftone UE series by Kao Corp., Polyester WR series by Nippon Synthetic Chemical Industry Co., Ltd., and Elitel series by Unitika Ltd.; and acrylic resins such as Hiros XE, KE, PE series by Seiko Chemical Industries Co., Ltd., and Jurymer ET series by Nihon Junyaku Co., Ltd.

The water-dispersible emulsion is not particularly limited and may be suitably selected in accordance with the intended use. Examples of the water-dispersible emulsion include water-dispersible polyurethane emulsions, water-dispersible polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, and methyl methacrylate-butadiene emulsions. Among them, water-dispersible polyester emulsions are preferred.

The water-dispersible polyester emulsions are preferably self-dispersible aqueous polyester emulsions, and among the self-dispersible aqueous emulsions, self-dispersible aqueous carboxyl-containing polyester emulsions are particularly preferable. Herein, the “self-dispersible aqueous polyester emulsion” means an aqueous emulsion containing a polyester resin that is self-dispersible in an aqueous solvent without the use of an emulsifier and the like. The “self-dispersible aqueous carboxyl-containing polyester emulsion” means an aqueous emulsion containing a polyester resin that contains carboxyl groups as hydrophilic groups and is self-dispersible in an aqueous solvent.

As the self-dispersible aqueous polyester emulsion preferably satisfies the following property requirements (1) to (4). This type of polyester resin emulsion is self-dispersible requiring no surfactant, is low in moisture absorbency even in an atmosphere at high humidity, exhibits less decrease in its softening point due to moisture and can thereby avoid offset in image-fixing and failures due to adhesion between sheets during storage. The emulsion is water-based and is environmentally friendly and excellent in workability. In addition, the polyester resin used herein readily takes a molecular structure with high coagulation energy. Accordingly, the resin has sufficient hardness (rigidity) during its storage but is melted with low elasticity and low viscosity during an image-fixing process for electrophotography, and the toner is sufficiently embedded in the toner image-receiving layer to thereby form images having sufficiently high quality.
(1) The number-average molecular weight (Mn) is preferably from 5,000 to 10,000, and more preferably from 5,000 to 7,000.
(2) The molecular weight distribution (Mw/Mn, weight mean molecular weight/number mean molecular weight) is preferably 4 or less, and more preferably 3 or less.
(3) The glass transition temperature (Tg) is preferably from 40° C. to 100° C., and more preferably 50° C. to 80° C.
(4) The volume mean diameter is preferably from 20 nm to 200 nm, and more preferably 40 nm to 150 nm

The content of the water-dispersible emulsion in the toner-image receiving layer is preferably from 10% by mass to 90% by mass, and more preferably 10% by mass to 70% by mass.

The water-soluble polymer is not particularly limited and may be suitably selected in accordance with the intended use, and may be suitably synthesized for use, or commercially available product may be used. Examples of the water-soluble polymer include polyvinyl alcohol, carboxy-modified polyvinyl alcohol, carboxymethyl cellulose, hydroxyethyl cellulose, cellulose sulfate, polyethylene oxides, gelatin, cationic starch, casein, sodium polyacrylate, sodium styrene-maleic acid anhydride copolymer, and sodium polystyrene sulfonate. Among the water-soluble polymers, polyethylene oxides are preferable.

Examples of commercially available products of water-soluble polymer include various Plascoat products by Goo Chemical Co., Ltd., Finetex ES series by Dainippon Ink and Chemicals Inc.; and those of water-soluble acrylic resins include Jurymer AT series by Nihon Junyaku Co., Ltd., Hiros NL-1189 and BH-997L by Seiko Chemical Industries Co., Ltd.

Examples of the water-soluble polymers are described on page 26 of Research Disclosure No. 17,643, page 651 of Research Disclosure No. 18,716, pp. 873-874 of Research Disclosure No. 307,105, and JP-A No. 64-13546.

The content of the water-soluble polymer in the toner image-receiving layer is not particularly limited and may be suitably selected in accordance with the intended use, preferably 0.5 g/m² to 2 g/m².

The thermoplastic resin for the toner image-receiving layer can be used in combination with other polymer materials. In this case, however, the thermoplastic resin for the toner image-receiving layer is to be greater in content than the other polymer materials.

In the toner image-receiving layer, the content of the thermoplastic resin for toner image-receiving layer is preferably 10% by mass or more, more preferably 30% by mass or more, still more preferably 50% by mass or more, and particularly preferable 50% by mass to 90% by mass.

Releasing Agent

The releasing agent is blended to the toner image-receiving layer in order to prevent offset of the toner image-receiving layer. Various types of releasing agents can be used and may be suitably selected in accordance with the intended use, provided that it is able to be heated and melted at a fixing temperature so as to deposit and remain on a surface of the toner image-receiving layer and is able to form a layer of releasing agent material on the surface of the toner image-receiving layer by being cooled and solidified

The releasing agent is at least one element selected from silicone compounds, fluorine compounds, waxes, and matting agents.

The releasing agent may be a compound described in “Properties and Applications of Wax (Revised)”, (Kaitei-Wakkusu no seishitsu to ouyou) by Saiwai Publishing, or in the Silicone Handbook published by THE NIKKAN KOGYO SHIMBUN. It is also possible to suitably use silicone compounds, fluorine compounds, waxes used in the toners written in Japanese Patent Application Publication (JP-B) Nos. 59-38581 and 04-32380, Japanese Patent (JP-B) No. 2838498, JP-B No. 2949558, Japanese Patent Application Laid-Open (JP-A) Nos. 50-117433, 52-52640, 57-148755, 61-62056, 61-62057, 61-118760, 0242451, 0341465, 04-212175, 04-214570, 04-263267, 05-34966, 05-119514, 06-59502, 06-161150, 06-175396, 06-219040, 06-230600, 06-295093, 07-36210, 0743940, 07-56387, 07-56390, 07-64335, 07-19968, 07-223362, 07-287413, 08-184992, 08-227180, 08-248671, 08-248799, 08-248801, 08-278663, 09-152739, 09-160278, 09-185181, 09-319139, 09-319143, 10-20549, 1048889, 10-198069, 10-207116, 11-2917, 1144969, 11-65156, 11-73049, and 11-194542. These compounds can also be used in combination of two or more.

Examples of the silicone compounds include silicone oil, silicone rubber, silicone fine-particles, silicone-modified resins, and reactive silicone compounds.

Examples of such silicone oils include unmodified silicone oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacrylic-modified silicone oil, mercapto-modified silicone oil, alcohol-modified silicone oil, alkyl-modified silicone oil, and fluorine-modified silicone oil.

Examples of the silicone-modified resins include silicone-modified resins derived from olefinic resins, polyester resins, vinyl resins, polyamide resins, cellulose resins, phenoxy resins, vinyl chloride-vinyl acetate resins, urethane resins, acrylic resins, styrene-acrylic resins, or resins that these copolymer resins are silicone-modified.

The fluorine compound is not particularly limited and may be suitably selected in accordance with the intended use. Examples of the fluorine compounds include fluorine oil, fluoro rubber, fluorine-modified resin, fluorine sulfonic acid compound, fluorosulfonic acid, fluorine acid compound or salt thereof, and inorganic fluoride.

The above waxes are largely classified into two, that is, natural wax and synthetic wax.

The natural wax is preferably at least one wax selected from vegetable wax, animal wax, mineral wax, and petroleum wax, and among these, vegetable wax is particularly preferable. The natural wax is also preferably a water-dispersible wax, from the viewpoint of compatibility and the like when an aqueous resin is used as the polymer for the toner image-receiving layer.

The vegetable wax is not particularly limited and may be suitably selected from among those known in the art. The vegetable wax may be a commercial product, or suitably synthesized.

Examples of the vegetable wax include carnauba wax, castor oil, rapeseed oil, soybean oil, Japan tallow, cotton wax, rice wax, sugarcane wax, candellila wax, Japan wax, and jojoba oil.

Examples of commercial product of the carnauba wax include EMUSTAR AR-0413 manufactured by Nippon Seiro Co., Ltd., and Cellusol 524 manufactured by Chukyo Yushi Co., Ltd. Examples of commercial product of castor oil include purified castor oil manufactured by Itoh Oil Chemicals Co., Ltd.

Among these, carnauba wax having a melting point of 70° C. to 95° C. is particularly preferable from the perspective of providing an electrophotographic material which is excellent in antioffset properties, adhesion resistance, paper transporting properties, gloss, is less likely to cause crack and splitting, and is capable of forming high-quality image.

The animal wax is not particularly limited and may be suitably selected among from those known in the art. Examples of the animal waxes include bees wax, lanolin, spermaceti, whale oil, and wool wax.

The mineral wax is not particularly limited and may be suitably selected from among those known in the art. The mineral wax may be a commercial product, or suitably synthesized. Examples of the mineral waxes include montan wax, montan ester wax, ozokerite, and ceresin. Among these mineral waxes, montan wax having a melting point of 70° C. to 95° C. is particularly preferable from the perspective of providing an electrophotographic material which is excellent in antioffset properties, adhesion resistance, paper transporting properties, gloss, is less likely to cause crack and splitting, and is capable of forming high-quality image.

The petroleum wax is not particularly limited and may be suitably selected among from those known in the art. The petroleum wax may be a commercial product, or suitably synthesized. Examples of the petroleum waxes include paraffin wax, microcrystalline wax, and petrolatum.

The content of the natural wax in the toner image-receiving layer is preferably 0.1 g/m² to 4 g/m², and more preferably 0.2 g/m² to 2 g/m².

When the content is less than 0.1 g/m², the antioffset properties and the adhesion resistance may become insufficient. When the content is more than 4 g/m², the quality of an image may deteriorate due to the excessive amount of wax.

The melting point of the natural wax is preferably 70° C. to 95° C., and more preferably 75° C. to 90° C., from the perspective of antioffset properties and paper transporting properties.

The synthetic waxes are classified into synthetic hydrocarbon, modified wax, hydrogenated wax, and other grease synthetic wax. The synthetic wax is preferably a water-dispersible wax, from the perspective of compatibility when an aqueous thermoplastic resin is used as the thermoplastic resin in the toner image-receiving layer.

Examples of the synthetic hydrocarbons include Fischertropsch wax, and polyethylene wax.

Examples of the grease synthetic waxes include an acid amide compound (specifically, stearic acid amide, and the like), an acid imide compound (specifically, anhydrous phthalic acid imide, and the like).

The modified wax is not particularly limited and may be suitably selected in accordance with the intended use. Examples of the modified wax include amine-modified wax, acrylic acid-modified wax, fluorine-modified wax, olefin-modified wax, urethane wax, and alcohol wax.

The hydrogenated wax is not particularly limited and may be suitably selected in accordance with the intended use. Examples of hydrogenated waxes include cured castor oil, castor oil derivatives, stearic acid, lauric acid, myristic acid, palmitic acid, behenic acid, sebacic acid, undecylenic acid, heptyl acid, maleic acid, and high grade maleic oils.

The melting point (° C.) of the releasing agent is preferably 70° C. to 95° C., and more preferably 75° C. to 90° C., from the viewpoint of antioffset properties and paper transporting properties.

The releasing agent according to the present invention which is added to a toner image-receiving layer may also use derivatives, oxides, refined products, or mixtures thereof. These may also have reactive substituents.

The content of the releasing agent, based on the mass of the toner image-receiving layer, is preferably 0.1% by mass to 10% by mass, more preferably 0.3% by mass to 8.0% by mass, and still more preferably 0.5% by mass to 5.0% by mass.

The content less than 0.1% by mass may make the antioffset property and adhesion resistance insufficient, while more than 10% by mass may deteriorate the quality of image due to too large an amount of releasing agent.

Plasticizers

The plasticizers are not particularly limited and may be suitably selected from among those known in the art. These plasticizers have the effect of adjusting the fluidity or softening of the toner image-receiving layer due to one of heat and pressure during the toner fixing.

The plasticizer may be selected by referring to “Chemical Handbook”, (Kagaku binran) (edited by The Chemical Society of Japan, Maruzen); “Plasticizers—Theory and Application”, (kasozai-Sono riron to ouyou) (edited by Koichi Murai, Saiwai Shobo); “The Study of Plasticizers, Part 1”, (Kasozai no kenkyu-jou); and “The Study of Plasticizers, Part 2”, (kasozai no kenkyu-ge) (edited by Polymer Chemistry Association); “Handbook of Rubber and Plastics Blending Agents”, (Binran-Gomu purasuchikku haigou yakuhin) (edited by Rubber Digest Co.), or the like.

As for the plasticizers, there are ones that are disclosed as high organic boilers and thermally melted solvents. Examples of the plasticizers include esters (such as phthalic esters, phosphate esters, aliphatic acid esters, abiethyne acid esters, adipic acid esters, sebacic acid esters, azelaic acid esters, benzoate esters, butylate esters, epoxy aliphatic acid esters, glycolic acid esters, propionic acid esters, trimellitic acid esters, citrates, sulfonates, carboxylates, succinic acid esters, maleic acid esters, fumaric acid esters, phthalic acid esters, and stearic acid esters); amides (such as aliphatic acid amides and sulfoamides); ethers; alcohols; lactones; and polyethyleneoxy (See JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 02-235694). The above plasticizers can be mixed into a resin for use.

The plasticizers may be polymers having relatively low molecular weight. In this case, it is preferred that the molecular weight of the plasticizer is lower than the molecular weight of the binder resin to be plasticized. Preferably, the plasticizers have a molecular weight of 15,000 or less, and more preferably 5,000 or less. When a polymer plasticizer is used as the plasticizer, the polymer plasticizer is preferably polymer kindred to the binder resin to be plasticized. For example, when the polyester resin is plasticized, polyesters having low molecular weight are preferably used. Further, oligomers may also be used as plasticizers.

Apart from the compounds mentioned above, there are commercial products such as Adecasizer PN-170 and PN-1430 (manufactured by Asahi Denka Co., Ltd.), PARAPLEX-G-25, G-30, and G-40 (manufactured by C.P. HALL Co.), Estergum 8L-JA, Ester R-95, Pentalin 4851, FK115, 4820, 830, Ruizol 28-JA, Picolastic A75, Picotex LC, and Cristalex 3085 (manufactured by Rika Hercules, Inc.).

The plasticizer can be used as arbitrarily to ease up stress and distortion (physical distortions such as elasticity and viscosity, and distortions due to mass balance in molecules, binder main chains or pendant portions) which are caused when toner particles are embedded in the toner image-receiving layer.

The plasticizer may be dispersed in micro in the toner image-receiving layer. The plasticizer may also be dispersed in micro, in a state of sea-island, in the toner image-receiving layer. The plasticizer may present in the toner image-receiving layer in a state of sufficiently mixed with other components such as binder.

The content of the plasticizer in the toner image-receiving layer is preferably 0.001% by mass to 90% by mass, more preferably 0.1% by mass to 60% by mass, and still more preferably 1% by mass to 40% by mass.

The plasticizer may be used for the purpose of adjusting slidability (improvement of transportability by reducing friction), improving fixing part offset (release of toner or layer to the fixing part), adjusting curl balance, and adjusting charge control (formation of a toner electrostatic image), and the like.

Colorant

The colorant is not particularly limited and may be suitably selected in accordance with the intended use. Examples of the colorants include fluorescent whitening agents, white pigments, colored pigments, and dyes.

The fluorescent whitening agent is not particularly limited and may be suitably selected among from those known in the art, as long as it has absorption in the near-ultraviolet region and is a compound which emits fluorescence at 400 nm to 500 nm. Examples of the fluorescent whitening agents include the compounds described in “The Chemistry of Synthetic Dyes” Volume V, Chapter 8 edited by K. VeenRataraman. The fluorescent whitening agent may be a commercially available product or suitably synthesized for use. Specific examples of the fluorescent whitening agents include stilbene compounds, coumarin compounds, biphenyl compounds, benzo-oxazoline compounds, naphthalimide compounds, pyrazoline compounds, and carbostyril compounds. Examples of commercial products of the fluorescent whitening agents include white fulfar-PSN, PHR, HCS, PCS, and B (respectively manufactured by Sumitomo Chemicals), and UVITEX-OB (manufactured by Ciba-Geigy, Co., Ltd.).

The white pigment is not particularly limited and may be suitably selected from among those known in the art in accordance with the intended use. Examples of the white pigments include inorganic pigments such as titanium oxide, and calcium carbonate.

The colored pigment is not particularly limited and may be suitably selected among from those known in the art in accordance with the intended use. Examples of the colored pigments include various pigments described in JP-A No. 63-44653, azo pigments, polycyclic pigments, condensed polycyclic pigments, lake pigments, and carbon black.

Examples of the azo pigments include azo lakes (such as carmine 6B and red 2B), insoluble azo pigments (such as monoazo yellow, disazo yellow, pyrazolo orange, and Balkan orange), condensed azo pigments (such as chromophthal yellow and chromophthal red).

Examples of the polycyclic pigments include phthalocyanines such as copper phthalocyanine blue, and copper phthalocyanine green.

Examples of the condensed polycyclic pigments include dioxazines (such as dioxazine violet), isoindolinones (such as isoindolinone yellow), threne pigments, perylene pigments, perinon pigments, and thioindigo pigments.

Examples of the lake pigments include malachite green, rhodamine B, rhodamine G, and Victoria blue B.

Examples of the inorganic pigments include oxides (titanium dioxide, iron oxide red, and the like), sulfates (settling barium sulfate, and the like), carbonates (settling calcium carbonate, and the like), silicates (hydrous silicate, silicic anhydride, and the like), metal powder (aluminum powder, bronze powder, zinc powder, chrome yellow, iron blue, and the like).

Each of these pigments may be used alone or in combination of two or more.

The dye is not particularly limited and may be suitably selected from among those known in the art in accordance with the intended use. Examples of dyes include anthraquinone compounds and azo compounds. These dyes may be used alone or in combination of two or more.

Examples of water-insoluble dyes include architecture dye, disperse dye, oil-soluble dye, and the like. Examples of the architecture dyes include C.I. Vat violet 1, C.I. Vat violet 2, C.I. Vat violet 9, C.I. Vat violet 13, C.I. Vat violet 21, C.I. Vat blue 1, C.I. Vat blue 3, C.I. Vat blue 4, C.I. Vat blue 6, C.I. Vat blue 14, C.I. Vat blue 20, and C.I. Vat blue 35. Examples of the disperse dyes include C.I. disperse violet 1, C.I. disperse violet 4, C.I. disperse violet 10, C.I. disperse blue 3, C.I. disperse blue 7, C.I. and disperse blue 58. Examples of the oil-soluble dyes include C.I solvent violet 13, C.I. solvent violet 14, C.I. solvent violet 21, C.I. solvent violet 27, C.I. solvent blue 11, C.I. solvent 12, C.I. solvent blue 25, and C.I. solvent blue 55.

Colored couplers used in silver halide photography may also be preferably used.

The content of the colorant in the toner image-receiving layer (surface) is preferably 0.1 g/m² to 8 g/m², and more preferably 0.5 g/m² to 5 g/m².

When the content of colorant is less than 0.1 g/m² or less, the light transmittance in the toner image-receiving layer may become high. When more than 8 g/m², it becomes difficult to handle crack and adhesion resistance.

Among the colorants, the amount of the added pigment is, based on the mass of the thermoplastic resin constituting the toner image-receiving layer, preferably 40% by mass or less, more preferably 30% by mass or less, and still more preferably 20% by mass or less.

The filler may be an organic or inorganic filler. Reinforcers for binder resins, bulking agents, and reinforcements known in the art may be used. The filler may be selected, referring to “Handbook of Rubber and Plastic Additives” (edited by Rubber Digest Co.), “Plastics Blending Agents—Basics and Applications” (New Edition) (Taisei Co.), and “The Filler Handbook” (Taisei Co.).

As the filler, various inorganic fillers or inorganic pigments can be used suitably. Examples of the inorganic fillers or inorganic pigments include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate, and mullite. Among these fillers, silica and alumina are particularly preferred. These fillers may be used alone or in combination of two or more. It is preferred that the filler has small particle diameter. When the particle diameter is large, the surface of the toner image-receiving layer tends to become rough.

The silica includes spherical silica and indefinite-form silica. The silica may be synthesized by the dry method, wet method or aerogel method. The surface of hydrophobic silica particles may also be treated with trimethylsilyl groups or silicone. Colloidal silica is preferred. The silica is preferably porous.

The alumina includes anhydrous alumina and hydrated alumina. Examples of crystallized anhydrous aluminas which may be used are α, β, γ, δ, ξ, η, θ, κ, ρ, and χ. Hydrated alumina is preferable to anhydrous alumina. The hydrated alumina may be a monohydrate or trihydrate. Monohydrates include pseudo-boehmite, boehmite, and diaspore. Trihydrates include gibbsite and byerite. The alumina is preferably porous.

The alumina hydrate can be synthesized by the sol-gel method, in which ammonia is added to an aluminum salt solution to precipitate alumina, or by hydrolysis of an alkali aluminate. Anhydrous alumina can be obtained by dehydrating alumina hydrate by the action of heat.

The amount of filler to be added is preferably from 5 parts by mass to 2,000 parts by mass relative to 100 parts by mass of the dry mass of the binder of the toner image-receiving layer.

A cross-linking agent can be added in order to adjust the storage stability or thermoplastic properties of the toner image-receiving layer. Examples of the cross-linking agents include compounds containing two or more reactive groups in the molecule, such as an epoxy group, an isocyanate group, an aldehyde group, and active halogen group, an active methylene group, an acetylene group, and other reactive groups known in the art.

The cross-linking agent may also be a compound having two or more groups capable of forming bonds such as hydrogen bonds, ionic bonds, and coordinate bonds.

As the cross-linking agent, it is possible to use the compounds known in the art as coupling agents for resin, curing agents, polymerizing agents, polymerization promoters, coagulants, film-forming agents, and film-forming assistants.

Examples of the coupling agents include chlorosilanes, vinylsilanes, epoxysilanes, aminosilanes, alkoxyaluminum chelates, titanate coupling agents. The examples further include other agents known in the art such as those mentioned in Handbook of Rubber and Plastics Additives” (Binran-Gomu purasuchikkusu no haigou yakuhin) edited by Rubber Digest Co.).

To the toner image-receiving layer according to the present invention, a charge control agent is preferably included to adjust toner transfer and adhesion to the toner image-receiving layer and to prevent charge adhesion of the toner image-receiving layer.

The charge control agent is not particularly limited and may be suitably selected from among various conventional charge control agents known in the art in accordance with the intended use. Examples of the charge control agents include surfactants such as a cationic surfactant, an anionic surfactant, an amphoteric surfactant, and a nonionic surfactant and further include polymer electrolytes and conductive metal oxides. Specific examples of the charge control agents include cationic charge inhibitors such as quaternary ammonium salts, polyamine derivatives, cation-modified polymethylmethacrylate, and cation-modified polystyrene; anionic charge inhibitors such as alkyl phosphates, and anionic polymers; and nonionic charge inhibitors such as aliphatic acid ester, and polyethylene oxide. The examples are not limited thereto, however.

When the toner has a negative charge, it is preferred that the charge control agent blended with the toner image-receiving layer is, for example, cationic or nonionic.

Examples of the conductive metal oxides include ZnO, TiO₂, SnO₂, A₂O₃, In₂O₃, SiO₂, MgO, BaO, and MoO₃. Each of these may be used alone or in combination of two or more. Moreover, the conductive metal oxide may contain (dope) other elements. For instance, ZnO may contain Al, In, or the like, TiO₂ may contain (dope) Nb, Ta, or the like, and SnO₂ may contain Sb, Nb, halogen elements, or the like.

Other Additives

The materials used for the toner image-receiving layer of the present invention may also contain various additives to improve image stability when output, or to improve stability of the toner image-receiving layer itself. Examples of the additives include various know antioxidants, age resistors, degradation inhibitors, ozone degradation inhibitors, ultraviolet ray absorbers, metal complexes, light stabilizers, preservatives, and fungicides.

The antioxidant is not particularly limited and may be suitably selected in accordance with the intended use. Examples of the antioxidants include chroman compounds, coumarane compounds, phenol compounds (for example, hindered phenols), hydroquinone derivatives, hindered amine derivatives, and spiroindan compounds. The antioxidants may be found in JP-A No. 61-159644.

Examples of the age resistors include those found in “Handbook of Rubber and Plastics Additives, Second Edition”, (Binran-Gomu purasuchikku haigou yakuhin-kaitei dai 2 han), (1993, Rubber Digest Co.,) pp. 76-121.

The ultraviolet ray absorber is not particularly limited and may be suitably selected in accordance with the intended use. Examples of the ultraviolet ray absorbers include benzotriazol compounds (described in the U.S. Pat. No. 3,533,794), 4-thiazolidone compounds (described in the U.S. Pat. No. 3,352,681), benzophenone compounds (described in JP-A No. 46-2784), and ultraviolet ray absorbing polymers (described in JP-A No. 62-260152).

The metal complex is not particularly limited and may be suitably selected in accordance with the intended use. Examples of the metal complexes include those described in U.S. Pat. Nos. 4,241,155, 4,245,018, and 4254195, and JP-A Nos. 61-88256, 62-174741, 63-199248, 01-75568, and 01-74272.

The ultraviolet ray absorbers and light stabilizers described in “Handbook of Rubber and Plastics Additives, Second Edition” (Binran-Gomu purasuchikku haigou yakuhin-kaitei dai 2 han) (1933, Rubber Digest Co.), pp. 122-137 are preferably used.

Additives for photography known in the art may also be added to the material used for the toner image-receiving layer as described above. Examples of the photographic additives may be found in the Journal of Research Disclosure (hereinafter referred to as RD) No. 17643 (December 1978), No. 18716 (November 1979), and No. 307105 (November 1989). The relevant sections are shown below.

TABLE 1

| Additive | RD17643 | RD18716 | RD307105 |
|---|---|---|---|
| Whitener | p. 24 | p. 648 right column | p. 868 |
| Stabilizer | pp. 24-25 | p. 649 right column | pp. 868-870 |
| Light absorber | pp. 25-26 | p. 649 right column | pp. 873 |
| (Ultraviolet ray absorber) | | | |
| Colorant image stabilizer | p. 25 | p. 650 right column | p. 872 |
| Film hardener | p. 26 | p. 651 left column | p. 874-875 |
| Binder | p. 26 | p. 651 left column | p. 873-874 |
| Plasticizer, Lubricant | p. 27 | p. 650 right column | p. 876 |
| Auxiliary application | pp. 26-27 | p. 650 right column | pp. 875-876 |
| agent (Surfactant) | | | |
| Antistatic agent | p. 27 | p. 650 right column | pp. 876-877 |
| Matting agent | — | — | pp. 878-879 |

The toner image-receiving layer according to the present invention is formed by applying a coating solution containing thermoplastic resin for the toner imager-receiving layer such as a wire coater to the support and by drying it. The minimum film-forming temperature (MFT) of the thermoplastic resin according to the present invention is preferably the room temperature or higher, from the perspective of pre-print storage, and preferably 100° C. or lower, from the perspective of fixing toner particles.

The toner image-receiving layer according to the present invention preferably has an application mass after drying in a range from 1 g/m² to 20 g/m², and more preferably 4 g/m² to 15 g/m².

Thickness of the toner image-receiving layer is not particularly limited and may be suitably selected in accordance with the intended use. For instance, the toner image-receiving layer is preferred to have a thickness of one-half or more of the particle diameter of used toner, and it is more preferred to have a thickness same as that of the toner particle to three times as thick as the used toner particle. Specifically, the thickness is preferably 1 μm to 50 μm, more preferably from 1 μm to 30 μm, still more preferably 2 μm to 20 μm, and particularly preferably 5 μm to 15 μm.

Physical Properties of Toner Image-Receiving Layer

The 180° separation strength of the toner image-receiving layer at the temperature for fixing with a fixing member is preferably 0.1N/25 mm or less, and more preferably 0.041N/25 mm or less. The 180° separation strength can be measured based on the method described in JIS K 6887 using the surface material of the fixing member.

It is preferred that the toner image-receiving layer has a high degree of whiteness. The whiteness is measured by the method specified in JIS P 8123, and is preferably 85% or more. It is preferred that the spectral reflectance is 85% or more in the wavelength range of 440 nm to 640 nm, and that the difference between the maximum spectral reflectance and the minimum spectral reflectance in this wavelength range is within 5%. Further, it is more preferred that the spectral reflectance is 85% or more in the wavelength range from 400 nm to 700 nm, and that the difference between the maximum spectral reflectance and the minimum spectral reflectance in the wavelength is within 5%.

Specifically, for the whiteness, the value of L* is preferably 80 or more, more preferably 85 or more, and still more preferably 90 or more in a CIE 1976 (L*a*b*) color space. The color tint of the white color is preferably as neutral as possible. Regarding the color tint of the whiteness, the value of (a*)²+(b*)² is preferably 50 or less, more preferably 18 or less, and still more preferably 5 or less in the (L*a*b*) space.

It is preferred that the toner image-receiving layer has a high surface gloss after an image being formed. The 45° gloss luster is preferably 60 or more, more preferably 75 or more, and still more preferably 90 or more, over the whole range from white where there is no toner, to black where toner is dense at maximum.

However, the gloss luster is preferably 110 or less. When it is more than 110, the image has a metallic luster, which is undesirable in terms of quality of image.

Gloss luster may be measured by JIS Z 8741.

It is preferred that the toner image-receiving layer has high surface planarity after fixing. The arithmetic average roughness (Ra) is preferably 31 μm or less, more preferably 1 μm or less, and still more preferably 0.5 μm or less, over the whole range from white where there is no toner, to black where toner is dense at maximum.

Arithmetic average roughness may be measured by JIS B 0601, JIS B 0651, and JIS B 0652.

It is preferred that the toner image-receiving layer has one of the following physical properties, more preferred that the toner image-receiving layer has several of the following physical properties, and still more preferred that the toner image-receiving layer has all of the following physical properties.
(1) Tm (melting temperature) of toner image-receiving layer is preferably 30° C. or more, and more preferably equal to or less than Tm (melting temperature of toner)+20° C.
(2) The temperature at which the viscosity of the toner image-receiving layer is 1×10⁵ cp is preferably 40° C. or higher, and more preferably lower than the corresponding temperature for the toner.
(3) At a fixing temperature of the toner image-receiving layer, the storage elasticity modulus (G′) is preferably 1×10² Pa to 1×10⁵ Pa, the loss elasticity modulus (G″) is preferably from 1×10² Pa to 1×10⁵ Pa.
(4) The loss tangent (G″/G′) which is the ratio of the loss elasticity modulus (G″) to the storage elasticity modulus (G′) at a fixing temperature of the toner image-receiving layer, is preferably from 0.01 to 10.
(5) The storage elasticity modulus (G′) at a fixing temperature of the toner image-receiving layer is preferably −50 to +2,500, relative to the storage elasticity modulus (G′) at a fixing temperature of the toner.
(6) The inclination angle on the toner image-receiving layer of a molten toner is preferably 500 or less, and more preferably 400 or less.

The toner image-receiving layer preferably satisfies the physical properties described in Japanese Patent No. 2788358, and JP-A Nos. 07-248637, 08-305067, and 10-239889.

It is preferred that the surface electrical resistance of the toner image-receiving layer is 1×10⁶ Ω/cm² to 1×10¹⁵ Ω/cm² (under conditions of 25° C., 65% RH).

When the surface electrical resistance is less than 1×10⁶ Ω/cm², the amount of toner transferred to the toner image-receiving layer is insufficient, and the density of the toner image obtained may be too low. On the other hand, when the surface electrical resistance is more than 1×¹⁵ Ω/cm², excessive charge than necessary is produced during transfer. Therefore, toner is transferred insufficiently, image density is low and static electricity develops, thus causing dust to adhere during handling of the electrophotographic image-receiving materials. Moreover, in this case, misfeed, overfeed, discharge marks, toner transfer dropout and the like may occur during the copying.

Herein, the surface electrical resistances are measured based on JIS K 6911. The sample is left with air-conditioning for 8 hours or more at a temperature of 20° C. and the humidity of 65% for humidity adjustment. Measurements are made using an R8340 manufactured by Advantest Ltd., under the same environmental conditions after giving an electric current for 1 minute at an applied voltage of 100V.

Other Layers

Other layers of the electrographic image-receiving paper sheet may include, for example, a surface protective layer, a back layer, an intermediate layer, a contact improving layer, an undercoat, a cushion layer, a charge control (inhibiting) layer, a reflecting layer, a tint adjusting layer, a preservability improving layer, an anti-stick layer, an anti-curl layer, a smoothing layer, and the like. These layers may have a single-layer structure or may be formed of tow or more layers.

Surface Protective Layer

The surface protective layer is formed on the surface of the toner image-receiving layer for the purpose of protecting the surface, improving preservability, improving handling property, giving writing property, improving machine passing property, giving antioffset property, and the like. The surface protective layer may have a single-layer structure or may be formed of two or more layers. As a binder, various thermoplastic resins, thermosetting resins and the like may be used for the surface protective layer. It is preferred that resins of the binder and the toner image-receiving layer are preferably of the same type. In this case, however, the surface protective layer and the toner image-receiving layer do not need to be the same in terms of thermodynamic property, electrostatic property, or the like. Those properties can be optimized separately.

The surface protective layer may be blended with the various additives described above that are usable for the toner image-receiving layer. Particularly, the surface protective layer can be blended with the releasing agent used according to the present invention and other additives such as matting agent. Various known matting agents are usable.

The top surface layer (for example, the surface protective layer when formed) is preferred to have compatibility with the toner in terms of fixability. Specifically, the top surface layer preferably has a contact angle relative to the melted toner in a range from 0° to 40°.

Back Layer

The back layer of the electrophotographic image-receiving materials is preferably formed on an opposite side of the toner image-receiving layer with respect to the support, for the purpose of giving a backface output property, improving output image quality of the backface, improving curl balance, improving machine passing property, and the like.

Color of the back layer is not particularly limited. In the case of both-side output image-receiving paper sheet in which the image is also formed on the backface, however, the color of the back layer is also preferred to be white. Like the surface, the back layer is preferred to have a whiteness of 85% or more and a spectral reflectance of 85% or more.

Moreover, for improving both-side output property, the back layer may have a structure same as that of the toner image-receiving layer side. The back layer may use the various additives as explained above. Particularly, additives like matting agent and charge control agent are preferably as the blended additives. The back layer may have a single-layer structure or may be formed of two or more layers.

When a mold-releasing oil is used for a fixing roller and the like for preventing offset during the fixing, the back layer may have oil absorbing property.

The back layer is preferred to have a thickness of 0.1 μm to 10 μm.

Contact Improving Layer

In the electrophotographic image-receiving materials, the contact improving layer is preferred to be formed for improving the contact (adherence) of the support and the toner image-receiving layer. The contact improving layer may be blended with various additives described above, particularly the cross-linking agent. Further, the electrophotographic image-receiving materials is preferred to have a cushion layer and the like between the contact improving layer and the toner image-receiving layer, for improving receptivity of the toner.

Intermediate Layer

The intermediate layer may be formed, for example, between the support and the contact improving layer, between the contact improving layer and the cushion layer, between the cushion layer and the toner image-receiving layer, between the toner image-receiving layer and the preservability improving layer, and the like. In the case of electrophotographic image-receiving materials which are formed with a support, a toner image-receiving layer, and an intermediate layer, the intermediate layer can be formed, for example, between the support and the toner image-receiving layer.

The thickness of the electrographic material according to the present invention is not particularly limited and may be suitably used in accordance with the intended use. For example, the thickness is preferably 50 μm to 550 μm, and more preferably 100 m to 350 μm.

<Toner>

The electrophotographic material according to the present invention is used by allowing the toner image-receiving layer to receive the toner during printing or copying.

The toner comprises a binder resin and a colorant, when necessary, further comprises a releasing agent, and the like.

Binder Resin of Toner

The binder resin is not particularly limited and may be suitably selected from among those used for toner in accordance with the intended use. Examples of the binder resin include vinyl monopolymer of: styrenes such as styrene, and parachlorostyrene; vinyl esters such as vinyl naphthalene, vinyl chloride, vinyl bromide, vinyl fluoride, vinyl acetate, vinyl propionate, vinyl benzoate, and vinyl butyrate; methylene aliphatic carboxylic acid esters such as methyl acrylate, ethyl acrylate, n-butyl acrylate, isobutyl acrylate, dodecyl acrylate, n-octyl acrylate, 2-chloroethyl acrylate, phenyl acrylate, α-methyl chloroacrylate, methyl methacrylate, ethyl methacrylate, and butyl acrylate; vinyl nitriles such as acrylonitrile, methacrylonitrile, and acrylamide; vinyl ethers such as vinyl methyl ether, vinyl ethyl ether, and vinyl isobutyl ether; N-vinyl compounds such as N-vinyl pyrrole, N-vinylcarbazole, N-vinyl indole, and N-vinyl pyrrolidone; and vinyl carboxylic acids such as methacrylic acid, acrylic acid, and cinnamic acid. These vinyl monomers may be used either alone, or copolymers thereof may be used. Further, various polyesters may be used, and various waxes may be used in combination with the above mentioned vinyl monomers.

Among these resins, it is preferred to use a resin of the same type as the resin used for the toner image-receiving layer of the present invention.

Colorant of Toner

The colorant is not particularly limited and may be suitably selected from among those ordinarily used for toner in accordance with the intended use. Examples of the colorants include various pigments such as carbon black, chrome yellow, Hansa yellow, Benzidine Yellow, threne yellow, quinoline yellow, permanent orange GTR, pyrazoline orange, Balkan orange, watch young red, permanent red, brilliant carmine 3B, brilliant carmine 6B, dippon oil red, pyrazoline red, lithol red, rhodamine B lake, lake red C, Rose Bengale, aniline blue, ultramarine blue, chalco oil blue, methylene blue chloride, phthalocyanine blue, phthalocyanine green, and malachite green oxalate. Other examples include various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenyl methane dyes, diphenyl methane dyes, thiazole dyes and xanthene dyes.

Each of these colorants may be used alone or in combination with two or more.

The content of the colorant is not particularly limited and may be selected in accordance with the intended use, preferably 2% by mass to 8% by mass. When the content of colorant is less than 2% by mass, tinting strength may be weaken, while more than 8% by mass, transparency may be impaired.

Releasing Agent of Toner

The releasing agent is not particularly limited and may be suitably selected among from those ordinarily used for toner in accordance with the intended use. Polar waxes containing nitrogen such as highly crystalline polyethylene wax having relatively low molecular weight, Fischertropsch wax, amide wax, and urethane wax are particularly effective.

For the polyethylene wax, it is effective when the molecular weight is 1,000 or less and is more preferably when the molecular weight is 300 to 1,000.

Since the compounds containing urethane bonds tend to stay in a solid state due to the strength of the coagulation force of the polar groups even if the molecular weight is lower, and since the melting point may be set higher with respect to the molecular weight, such compounds are suitable in general. The preferred molecular weight is 300 to 1,000. The raw material may be selected from various combinations such as diisocyanic acid compound with a mono-alcohol, a monoisocyanic acid with mono-alcohol, dialcohol with a mono-isocyanic acid, tri-alcohol with a monoisocyanic acid, and a triisocyanic acid compound with a mono-alcohol. However, in order to prevent the molecular weight from becoming too large, it is preferable to combine a compound having multiple functional groups with another compound having one functional group, and it is important that the amount of functional groups be equivalent.

Examples of the monoisocyanic acid compounds include dodecyl isocyanate, phenyl isocyanate, and derivatives thereof, naphthyl isocyanate, hexyl isocyanate, benzyl isocyanate, butyl isocyanate, and allyl isocyanate.

Examples of the diisocyanic acid compounds include tolylene diisocyanate, 4,4′ diphenylmethane, toluene diisocyanate, 1,3-phenylene diisocyanate, hexamethylene diisocyanate, 4-methyl-m-phenylene diisocyanate, and isophorone diisocyanate.

Examples of the monoalcohols include methanol, ethanol, propanol, butanol, pentanol, hexanol, and heptanol.

Examples of the dialcohols include various glycols such as ethylene glycol, diethylene glycol, triethylene glycol, and trimethylene glycol.

Examples of the trialcohols include trimethylol propane, triethylol propane, and trimethanol ethane.

Like an ordinary releasing agent, the above noted urethane compounds can be mixed with resin or colorant during kneading, to be used as a mixed-pulverized toner. When used for the toner of the emulsion polymerization melting method, the urethane compound is to be dispersed in water in combination with the ion surfactant or high molecular electrolyte such as high molecular acid or high molecular base, and then heated to the melting point or more, then subjected to a strong shearing caused by a homogenizer or a pressure discharge type dispersing apparatus for forming fine particles to thereby prepare releasing agent particle-containing dispersing liquid (particle: 1 μm or less) which can be used in combination with the resin particle-containing dispersing liquid, the colorant-containing dispersing liquid, and the like.

Other Components of Toner

The toner can be blended with other components such as inner additives, charge control agents, inorganic fine particles. Examples of the inner additives include metals such as ferrite, magnetite, reduced iron, cobalt, nickel, and manganese; alloy; and magnetic bodies such as compounds including the above metals.

Examples of the charge control agents include those ordinarily used such as quaternary ammonium salts, nigrosine compounds, dyes made of complexes (such as aluminum, iron, and chrome), and triphenyl methane pigments. It is preferable that the charge control agent is unlikely to be soluble in water, from the viewpoint of controlling ion strength which may cause an effect on stability during coagulation or melting and from the viewpoint of reducing waste water pollutant.

Examples of the inorganic particles include all the outer additives ordinarily used on the toner surface such as silica, alumina, titania, calcium carbonate, magnesium carbonate, and tricalcium phosphate. The above particles are preferably used by dispersing with ion surfactant, high molecular acid, and high molecular base.

Surfactants may also be used for emulsion polymerization, seed polymerization, pigment dispersion, resin particle dispersion, releasing agent dispersion, coagulation or stabilization thereof. For example, it is effective to use, in combination with anionic surfactants such as sulfuric acid ester salts, sulfonic acid salts, phosphoric acid esters, and soaps; cationic surfactants such as amine salts, and quaternary ammonium salts; or nonionic surfactants such as polyethylene glycols, alkylphenol ethylene oxide adducts, and polyvalent alcohols. These may generally be dispersed by a rotary shear homogenizer or a ball mill, sand mill, and dyno mill, all of which contain media.

When necessary, an outer additive may be added to the toner. Examples of the outer additives are inorganic particles or organic particles. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, A₂O₃.2SiO₂, CaCO₃, MgCO₃, BaSO₄, and MgSO₄. Examples of the organic particles include fatty acids or derivatives thereof, powders of the above metallic salts and the like, and resin particles such as fluorine resin, polyethylene resin, and acrylic resin.

Average particle diameter of the above is preferably from 0.01 μm to 5 μm, and more preferably 0.1 μm to 2 μm.

There is no particular limitation on the process of manufacturing the toner and it is may be suitably selected in accordance with the intended use, but it is preferably manufactured by a process comprising the steps of (i) forming coagulation particles in a dispersion of resin particles to prepare a coagulation particle dispersion, (ii) adding a fine particle dispersion to the coagulation particle dispersion so that the fine particles adhere to the coagulation particles, thus forming adhesion particles, and (iii) heating the adhesion particles to be melted to form toner particles.

Physical Properties of Toner

The toner used in the present invention preferably has a volume mean diameter of 0.5 μm to 10 μm. The particle diameter lower than the above range may cause a negative effect on toner handling (supplying property, cleaningability, fluidity, and the like), and may decrease particle productivity. While the particle diameter larger than the above range may afford negative effects on image quality and resolution attributable to granulariness and transferability.

It is preferable that the toner used in the present invention satisfies the above mentioned range of volume mean diameter and has a distribution index of volume mean diameter (GSDv) being 1.3 or less.

The ratio (GSDv/GSDn) of the distribution index of volume mean diameter (GSDv) to a distribution index of number mean diameter (GSDn) is preferably 0.95 or more.

It is also preferable that the toner according to the present invention satisfies the above range of volume average particle diameter and has an average of configuration indexes (being 1.00 to 1.50), which is expressed by the following expression.
Configuration index=(πXL²)/(4XS)
(where L denotes the maximum length of toner particle, and S denotes the projected area of toner particle)

The toner satisfying the above conditions can bring about favorable effects on image quality, particularly on granulariness and resolution. With such a toner, dropouts and blurs which may be caused by transfer are unlikely to occur, and handling may be unlikely influenced even when the average particle diameter is not small.

From the perspective of improving image quality and preventing offset during the fixing step, it is preferable that the toner itself has a storage elasticity modulus G′ (measured at an angle frequency of 10 rad/sec.) of 1×10² Pa to 1×10⁵ Pa at 150° C.

<Silver Salt Photographic Material>

The silver salt photographic material has, for example, a configuration in which an image-recording layer which develops at least yellow, magenta and cyan (YMC) is disposed on an image-recording material support according to the present invention. The material is generally used in, for example, silver halide photography in which an exposed and printed silver halide photographic sheet is soaked in several treatment baths one after another so as to perform color developing, bleaching and fixing, washing with water, and drying.

<Inkjet-Recording Material>

The inkjet-recording material includes, for example, a colorant-receiving layer disposed on an image-recording material support according to the present invention, where the colorant-receiving layer is capable of receiving a liquid ink such as an aqueous ink (using a pigment or dye as the colorant) and oil ink; a solid ink which is solid at room temperature but is melted and liquefied when used for a print, and the like.

<Heat Transfer Material>

The heat transfer material has, for example, a configuration in which at least a heat-melting ink layer as an image-recording layer is disposed on an image-recording material support of the present invention. The heat transfer material is generally used in, for example, a method in which a heat sensitive head heats the heat-melting ink layer so as to melt and transfer the ink to a heat transfer sheet.

<Heat Sensitive Material>

The heat sensitive material has, for example, a configuration in which at least a heat-coloring layer is disposed on an image-recording material support of the present invention. Examples thereof include, but are not limited to, heat sensitive materials used in thermo-autochrome method (TA method) in which repetition of heating by a heat sensitive head and fixing by ultraviolet ray forms an image.

<Sublimation Transfer Material>

The sublimation transfer material has, for example, a configuration in which at least an ink layer containing a heat-diffusion pigment (subliming pigment) is disposed on an image-recording material support according to the present invention. The sublimation transfer material is generally used in, for example, a sublimation transfer method in which a heat sensitive head heats an ink layer so as to transfer the heat-diffusion pigment to a sublimation transfer sheet.

<Printing Paper>

The image-recording material support is preferably used as printing paper. In this case, the support is preferred to have high mechanical strength since the ink is to be applied by means of a printing machine.

When raw paper (base paper) is used as the printing paper, it is preferred to include a filling material(s), a softener(s), an inner additive assistant(s) for paper-making, and the like. The filling materials ordinarily used are usable. Examples thereof include inorganic filling materials such as clay, firing clay, diatom earth, talc, kaolin, firing kaolin, delaminated kaolin, heavy calcium carbonate, soft calcium carbonate, magnesium carbonate, barium carbonate, titanium dioxide, zinc oxide, silicon oxide, amorphous silica, aluminum hydroxide, calcium hydroxide, magnesium hydroxide, and zinc hydroxide; and organic filling materials such as urea-formalin resin, polystyrene resin, phenol resin, and minor hollow particle. Each of these fillings may be used alone or in combination with two or more.

Examples of the inner additive assistants for paper-making include those conventionally used such as various kinds of yield promoters which are nonionic, cationic, and anionic; freeness promoters, paper force promoters; and inner additive sizing agents. Specific examples thereof include basic aluminum compounds such as aluminum sulfate, aluminum chloride, sodium aluminate, basic aluminum chloride, basic polyaluminum hydroxides; polyvalent metal compounds such as ferrous sulfate, and ferric sulfate; water soluble high polymers such as starch, modified starch, polyacrylamide, urea resin, melamine resin, epoxy resin, polyamide resin, polyamine resin, polyamine, polyethylene imine, plant gum, polyvinyl alcohol, latex, and polyethylene oxide; various compounds such as hydrophilic cross-linking agent polymer particle dispersion, derivatives thereof, and modified product thereof. The above materials have several functions at the same time as inner additive assistants for the paper-making.

Examples of materials having a remarkable function as inner sizing agent include alkyl ketene dimer compounds, alkenyl succinic anhydride compounds, styrene-acrylic compounds, higher fatty acid compounds, petroleum resin sizing agents, and rosin sizing agents.

When necessary, the inner sizing agents may include, in accordance with the intended use, those for paper-making such as dyes, fluorescent whitening agents, pH regulators, defoaming agents, pitch control agents, and slime control agents.

The printing paper is particularly preferable for offset printing paper. The other applications include relief printing paper, gravure printing paper, and electrophotographic paper.

The image-recording material according to the present invention has image recording material support having high surface planarity and excellent gloss and an image recording layer on the support, and causes excellent gloss. Therefore, the image-recording material according to the present invention is preferably used for electrophotographic material, heat sensitive material, inkjet-recording material, sublimation transfer material, silver salt photographic material, and heat transfer material.

Hereafter, the present invention will be described by means of examples and comparative examples, but it will be understood that the present invention is not construed as being limited thereto.

### Example 1

Preparation of Image-Recording Material Support

Broad-leaf (hardwood) tree bleached kraft pulp (LBKP) was beaten to a Canadian Standard Freeness (C.S.F) of 300 ml using a disk refiner to thereby prepare a pulp paper material having fiber length of 0.58 mm.

To this pulp paper material, the following additives were added on the basis of the pulp mass: cation starch 1.2% by mass, alkyl ketene dimer (AKD) 0.5% by mass, anion polyacrylamide 0.2% by mass, epoxidized fatty acid amide (EFA) 0.2% by mass, and polyamide polyamine epichlorohydrine 0.3% by mass. An alkyl part of the above alkyl ketene dimer originates from a fatty acid having a main component of behenic acid. A fatty acid part of the epoxidized fatty acid originates from a fatty acid having a main component of behenic acid.

Thereafter, the pulp paper material was treated with a manual paper-making machine to make wet paper having an absolute dry weight of 160 g/m² and water content of 68%.

Both sides of the obtained wet paper were covered with filter paper and dehydrated using a wet press apparatus to adjust water content to 50%.

The dehydrated wet paper was then dried with a press dry treatment apparatus similar to the one shown in FIG. 1 (Static Condebelt, manufactured by VALMET) to prepare raw paper with water content of 7.0% after drying. The press dry treatment was performed in a condition where the temperature of an upper plate which was in contact with the raw paper on the side (surface) where an image-recording layer was to be formed was set at 150° C., the temperature of a lower plate which was in contact with the raw paper on the side (backface) where no image-recording layer was to be formed was set at 85° C., pressure was set at 0.4 MPa, and drying time was set at 1 second.

Next, calcium carbonate (average particle diameter=1.9 μm) 80 parts by mass, TiO₂ 20 parts by mass, acryl emulsion (glass transition temperature (Tg)=65° C.) 25 parts by mass, starch 5 parts by mass, and an appropriate amount of water were mixed to prepare a polymer containing aqueous coating solution having a solid content of 60% by mass. The polymer containing aqueous coating solution was applied with a blade coater to the side of raw paper to be formed with the image-recording layer such that its solid content becomes 6 g/m².

Next, the surface of the coated layer was dried by hot-air so as to have a water content of 20% and then subjected to press and dry treatment to prepare a raw paper having a water content of coat layer after drying of 7.0%. The press dry treatment was performed in a condition where the temperature of an upper plate which was in contact with the raw paper on the side (surface) where an image-recording layer was to be formed was set at 110° C., the temperature of a lower plate which was in contact with the raw paper on the side (backface) where no image-recording layer was to be formed was set at 70° C., pressure was set at 0.1 MPa, and drying time was set at 1 second.

The press-dry-treated raw paper was then calendered for a heat calender treatment using a soft calender apparatus under the following conditions. The paper was passed through so that a metal roller having a surface temperature of 190° C. was in contact with the side (surface) of the raw paper on which an image-recording layer was to be formed, while allowing a resin roller on the opposite side to have a set surface temperature of 40° C. The obtained paper for an image recording material support had a density of 0.98 g/cm³.

### Examples 2 to 4 and Comparative Examples 1 to 5

Papers as image recording material supports for Examples 2 to 4 and Comparative Examples 1 to 5 were prepared in the same manner as Example 1 provided that the paper-making conditions were changed to those shown in Table 2.

TABLE 2

| | | An amount | | | |
|---|---|---|---|---|---|
| | Dry before | of coat | Dry after | Heat | Density |
| | coating | (g/m²) | coating | calender | (g/cm³) |
| Ex. 1 | Press dry | 6 | Press dry | With | 0.98 |
| Ex. 2 | Cylinder dry | 6 | Press dry | Without | 0.86 |
| Ex. 3 | Cylinder dry | 6 | Press dry | With | 0.99 |
| Ex. 4 | Press dry | 6 | Press dry | Without | 0.87 |
| Compara. | Cylinder dry | 6 | Cylinder dry | Without | 0.73 |
| Ex. 1 | | | | | |
| Compara. | Cylinder dry | 6 | Cylinder dry | With | 0.85 |
| Ex. 2 | | | | | |
| Compara. | Cylinder dry | 6 | Cylinder dry | With | 0.99 |
| Ex. 3 | | | | | |
| Compara. | Cylinder dry | 6 | Cylinder dry | With | 1.08 |
| Ex. 4 | | | | | |
| Compara. | Cylinder dry | — | Cylinder dry | Without | 0.74 |
| Ex. 5 | | | | | |

The papers (image-recording material supports) of Examples 1 to 4 and Comparative Examples 1 to 5 were evaluated as mentioned below in terms of gloss, surface planarity (smoothness), and rigidity (stiffness). Table 3 shows the results.

<Evaluation of Gloss>

The gloss of each support was visually observed and was evaluated. The support with the best gloss was assigned A, followed by B, C, D, E on the following basis.

[Evaluation Standards]

A: Very good
B: Good
C: Mediocre
D: Poor
E: Very poor
   <Evaluation of Surface Planarity>

Based on below measuring conditions and analysis conditions, a surface configuration measuring apparatus, SURFCOM 570A-3DF (manufactured by Tokyo Seimitsu CO., LTD.), was used for measuring the average center surface roughness (SRa) on the side (of the image-recording material support) to be formed with the image-recording layer, at the cutoff wavelength of 5 mm to 6 mm.

Measuring Conditions and Analysis Conditions

Scanning direction: MD direction of sample
Measuring length: Machining paper direction (X-direction) 50 mm, and perpendicular direction (Y-direction) thereto 30 mm
Measuring pitch: X-direction 0.1 mm, Y-direction 0.1 mm.
Scanning speed: 30 mm/sec.
Band pass filter: 5 mm to 6 mm
   [Evaluation Standards]
A: Very good (SRa is 0.3 μm or less)
B: Good (SRa is less than 0.51 μm)
C: Mediocre (SRa is 0.51 μm to less than 1.0 μm)
D: Poor (SRa is 1.0 to less than 2.0 μm)
E: Very poor (SRa is 2.0 μm or more)<
   <Evaluation of Rigidity>

Rigidity (stiffness) of the obtained image-recording material supports was evaluated by hand-touch based on standard 1 to standard 5, where the greater the figure is the better the rigidity (stiffness) is. Table 3 shows the results.

TABLE 3

| | Surface | | Rigidity |
|---|---|---|---|
| | Planarity | Gloss | (Stiffness) |
| Ex. 1 | A | A | 4 |
| Ex. 2 | B | B | 4 |
| Ex. 3 | A | B | 4 |
| Ex. 4 | B | A | 4 |
| Compara. | E | E | 4 |
| Ex. 1 | | | |
| Compara. | D | D | 4 |
| Ex. 2 | | | |
| Compara. | C | D | 3 |
| Ex. 3 | | | |
| Compara. | B | C | 2 |
| Ex. 4 | | | |
| Compara. | E | E | 4 |
| Ex. 5 | | | |

### Examples 5 to 8 and Comparative Examples 6 to 10

The paper sheets (image-recording material supports) of Examples 1 to 4 and Comparative Examples 1 to 5 were used for preparing the electrophotographic image-receiving paper sheets respectively of Examples 5 to 8 and Comparative Examples 6 to 10, in the following methods.

Titanium Dioxide Dispersion Solution

The following components were blended and dispersed using an non-bubbling kneader (NBK-2, manufactured by Nippon Seiki Co., Ltd.) to prepare a titanium dioxide dispersion solution (titanium dioxide pigment: 40% by mass).

| | | |
|---|---|---|
| Titanium dioxide | 40.0 | g |
| (TIPAQUE (registered Trademark) A-220, manufactured by | | |
| Ishihara Sangyo Kaisha, Ltd.) | | |
| Polyvinyl alcohol | 2.0 | g |
| (PVA102, manufactured by Kuraray Co., Ltd.) | | |
| Ion exchange water | 58.0 | g |

Preparation of Coating Solution for Toner-Receiving Layer

The following components were mixed and stirred to prepare the coating solution for toner image-receiving layer.

| | | |
|---|---|---|
| The above-mentioned titanium dioxide dispersion solution | 15.5 | g |
| Carnauba wax dispersion solution | 15.0 | g |
| (Cellosol 524, manufactured by Chukyo Yushi Co., Ltd.) | | |
| Polyester resin aqueous dispersion | 100.0 | g |
| (solids 30% by mass, KZA-7049, Unitika Ltd.) | | |
| Thicker (Alcox E30, MEISEI CHEMICAL WORKS, LTD) | 2.0 | g |
| Anionic surfactant (AOT) | 0.5 | g |
| Ion exchange water | 80 | ml |

The obtained coating solution for toner image-receiving layer had a viscosity of 40 mPa·s and a surface tension of 34 mN/m.

Preparation of Back Layer Coating Solution

The following components were mixed and stirred to prepare a back layer coating solution.

| | | |
|---|---|---|
| Acrylate resin aqueous dispersion | 100.0 | g |
| (solids 30% by mass, High-Loss XBH-997L, manufactured by | | |
| Seiko Chemical Industries Co., Ltd.) | | |
| Matting agent | 5.0 | g |
| (Techpolymer MBX-12, manufactured by Sekisui Plastics | | |
| Co., Ltd.) | | |
| Releasing agent (Hydrin D337, Chukyo Yushi Co., Ltd.) | 10.0 | g |
| Thicker (CMC) | 2.0 | g |
| Anionic surfactant (AOT) | 0.5 | g |
| Ion exchange water | 80 | ml |

The obtained back layer coating solution has a viscosity of 35 mPa·s and a surface tension of 33 mN/m.

Coating of Back Layer and Toner Image-Receiving Layer

To the backface (namely, the side not to be formed with the toner image-receiving layer) of the image-recording material support of each of Examples 1 to 4 and Comparative Examples 1 to 5, the back layer coating solution was applied with a bar coater, such that the coating amount was 9 g/m² in dry mass, to thereby form the back layer. Then, to the surface of the image-recording material support, the coating solution for toner image-receiving layer was applied with a bar coater in the same manner as the back layer, such that the coating amount was 12 g/m² in dry mass, to thereby form the toner image-receiving layer. The content of the pigment in the toner image-receiving layer was 5% by mass, relative to the mass of the thermoplastic resin.

After the back layer and the toner image-receiving layer were coated, they were dried by hot air, online. Airflow and temperature for drying were adjusted, so that both the bock layer and the toner image-receiving layer were dried within 2 minutes after the coating. The point of dryness was determined when the surface temperature of the coating was equal to the wet-bulb temperature of the airflow for drying.

After the drying, a calender treatment was performed. A gloss calender was used for the calender treatment in which the temperature of a metal roller was maintained at 40° C. and a nip pressure was set at 15 kgf/cm².

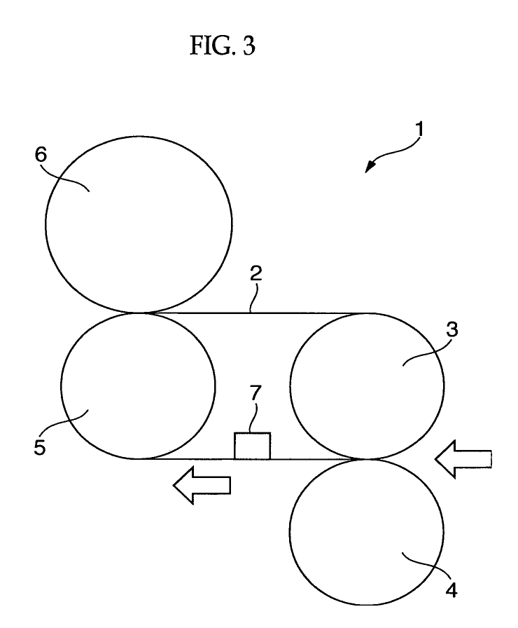

Each of the obtained electrophotographic image-recording paper sheets was cut to A4 size, and image was printed thereon using a printer for electrophotography. The printer used here was a color laser printer (DocuColor 1250-PF) produced by Fuji Xerox Co., Ltd., excluding that a fixing belt apparatus 1 shown in FIG. 3 was installed.

Specifically, in the fixing belt apparatus 1 as shown in FIG. 3, a fixing belt 2 is spanned over a heating roller 3 and a tension roller 5. A cleaning roller 6 is provided via the fixing belt 2 above the tension roller 5, and a pressurizing roller 4 is further provided via the fixing belt below the heating roller 3. In FIG. 3, starting from the right-hand side, the electrophotographic image-receiving paper sheet carrying a toner latent image was introduced between the heating roller 3 and the pressurizing roller 4, was fixed and then transported on the fixing belt 2. Thereafter, in the process, the electrophotographic image-receiving paper sheet was cooled by a cooling device 7, and the fixing belt 2 was finally cleaned by a cleaning roller 6.

In the fixing belt apparatus 1, the transport speed at the fixing belt 2 is 30 mm/sec. the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was set at 120° C.

For each electrophotographic print obtained, image quality, gloss and rigidity (stiffness) were evaluated in the following manner. Table 4 shows the results.

<Evaluation of Image Quality>

The image quality of each electrophotographic print was visually observed and was evaluated. The print with the best image quality was assigned A, followed by B, C, D, and E on the following basis.

[Evaluation Standards]

A: Very good (Effective for high image quality recording material)
B: Good (Effective for high image quality recording material)
C: Mediocre (Ineffective for high image quality recording material)
D: Poor (Ineffective for high image quality recording material)
E: Very poor (Ineffective for high image quality recording material)<
   <Evaluation of Gloss>

The gloss of each electrophotographic print was visually observed and was evaluated. The print with the best gloss was assigned A, followed by B, C, D and E on the following basis.

[Evaluation Standards]

A: Very good (Effective for high image quality recording material)
B: Good (Effective for high image quality recording material)
C: Mediocre (Ineffective for high image quality recording material)
D: Poor (Ineffective for high image quality recording material)
E: Very poor (Ineffective for high image quality recording material)<
   <Evaluation of Rigidity (Stiffness)>

The rigidity (stiffness) of each electrophotographic print obtained was evaluated by hand-touch based on standard 1 to standard 5, where the greater the figure is the better the rigidity (stiffness) is.

TABLE 4

| | Image-recording | | | |
|---|---|---|---|---|
| | material | | Image | Rigidity |
| | support | Gloss | quality | (stiffness) |
| Ex. 5 | Ex. 1 | A | A | 4 |
| Ex. 6 | Ex. 2 | A | A | 4 |
| Ex. 7 | Ex. 3 | A | A | 4 |
| Ex. 8 | Ex. 4 | A | A | 4 |
| Compara. | Compara. | D | D | 4 |
| Ex. 6 | Ex. 1 | | | |
| Compara. | Compara. | C | D | 4 |
| Ex. 7 | Ex. 2 | | | |
| Compara. | Compara. | C | C | 3 |
| Ex. 8 | Ex. 3 | | | |
| Compara. | Compara. | B | C | 2 |
| Ex. 9 | Ex. 4 | | | |
| Compara. | Compara. | E | E | 4 |
| Ex. 10 | Ex. 5 | | | |

### Examples 9 to 12 and Comparative Examples 11 to 15

Preparation of Photographic Printing Paper

With the image-recording material supports prepared in Examples 1 to 4 and Comparative Examples 1 to 5, 0.1 g/m² of gelatin was applied to the side (surface) to be formed with the image-recording layer. The obtained gelatin coat face was further coated with the overlapping coatings in the following order of: i) a silver halide gelatin emulsion layer (10 g/m²) for yellow coloring photograph, ii) a gelatin intermediate layer, iii) a silver halide gelatin emulsion layer (10 g/m²) for magenta coloring photograph, iv) a gelatin intermediate layer, v) a silver halide gelatin emulsion layer (10 g/m²) for cyanogen coloring photograph, and vi) a gelatin protective layer, respectively, to thereby prepare each photographic printing paper of Examples 9 to 12 and Comparative Examples 11 to 15.

The obtained photographic printing papers were exposed and developed to prepare photographic prints. For each photographic print, surface planarity (small-scale irregularity (1 mm or less) and large-scale irregularity (5 mm to 6 mm)) was evaluated in the following manner. Table 5 shows the results.

<Evaluation of Surface Planarity (Small-Scale Irregularity (1 mm or Less))>

The surface appearance of each photographic print was visually observed and evaluated. The print with the best surface planarity (small-scale irregularity (1 mm or less)) was assigned A, followed by B, C, D and E on the following basis.

[Evaluation Standards]

A: Very good (Effective for high image quality recording material)
B: Good (Effective for high image quality recording material)
C: Mediocre (Ineffective for high image quality recording material)
D: Poor (Ineffective for high image quality recording material)
E: Very poor (Ineffective for high image quality recording material)<
   <Evaluation of Surface Planarity (Large-Scale Irregularity (5 mm to 6 mm))>

The surface appearance of each photographic print was visually observed and evaluated. The print with the best surface planarity (large-scale irregularity (5 mm to 6 mm) was assigned A, followed by B, C, D and E on the following basis.

[Evaluation Standards]

A: Very good (Effective for high image quality recording material)
B: Good (Effective for high image quality recording material)
C: Mediocre (Ineffective for high image quality recording material)
D: Poor (Ineffective for high image quality recording material)

E: Very poor (Ineffective for high image quality recording material)

TABLE 5

| | | Small-scale | Large-scale |
|---|---|---|---|
| | Image-recording | irregularity | irregularity |
| | material support | (1 mm or less) | (5 mm to 6 mm) |
| Ex. 9 | Ex. 1 | A | A |
| Ex. 10 | Ex. 2 | A | A |
| Ex. 11 | Ex. 3 | A | A |
| Ex. 12 | Ex. 4 | A | A |
| Compara. | Compara. | D | E |
| Ex. 11 | Ex. 1 | | |
| Compara. | Compara. | C | D |
| Ex. 12 | Ex. 2 | | |
| Compara. | Compara. | C | D |
| Ex. 13 | Ex. 3 | | |
| Compara. | Compara. | B | C |
| Ex. 14 | Ex. 4 | | |
| Compara. | Compara. | E | E |
| Ex. 15 | Ex. 5 | | |

A paper sheet according to the present invention and an image-recording material support made from the paper has high surface planarity and excellent gloss. The paper sheet and the image-recording material support can be widely used for various kinds of image-recording materials such as electrophotographic materials, heat sensitive materials, inkjet recording materials, sublimation transfer materials, silver salt photographic materials, and heat transfer materials.

What is claimed is:

1. A paper comprising:
a raw paper, and
a polymer-containing layer on at least one surface of the raw paper to be formed with an image recording layer,
wherein the paper is produced by subjecting to a press dry treatment.

2. The paper according to claim 1, wherein the raw paper is made from a wet paper which is produced by subjecting to a press dry treatment.

3. The paper according to claim 1, wherein the polymer-containing layer comprises any one of a water-soluble polymer and a water-dispersible polymer emulsion.

4. The paper according to claim 1, wherein the polymer-containing layer comprises a pigment.

5. A method for manufacturing a paper comprising:
forming a polymer-containing layer on at least one surface of a raw paper to be formed with an image-recording layer, and
pressing and drying the raw paper on which the polymer-containing layer is formed.

6. The method for manufacturing a paper according to claim 5, wherein the press and dry treatment is performed to the raw paper before subjecting to a calender treatment.

7. The method for manufacturing a paper according to claim 5, wherein the polymer-containing layer is formed on at least one surface of a raw paper which is made from a wet paper produced by subjecting to a press dry treatment.

8. The method for manufacturing a paper according to claim 5, wherein the raw paper is dried until the polymer-containing layer has a water content of 5% to 30% before subjected to the press dry treatment.

9. The method for manufacturing a paper according to claim 5, wherein the pressure of the press dry treatment is 0.05 MPa to 0.5 MPa.

10. An image-recording material support comprising:
a raw paper, and
a polymer-containing layer on at least one surface of the raw paper to be formed with an image-recording layer,
wherein the raw paper is made from a paper which is produced by subjecting to a press dry treatment.

11. The image-recording material support according to claim 10, wherein the raw paper is made from a wet paper which is produced by subjecting to a press dry treatment.

12. The image-recording material support according to claim 10, wherein the polymer-containing layer comprises any one of a water-soluble polymer and a water-dispersible polymer emulsion.

13. The image-recording material support according to claim 10, wherein the polymer-containing layer comprises a pigment.

14. An image-recording material comprising:
a support, and
an image-recording layer disposed on the support,
wherein the support comprises a raw paper and a polymer-containing layer on at least one surface of the raw paper to be formed with an image-recording layer and is made from a paper which is produced by subjecting to a press dry treatment.

15. The image-recording material according to claim 14, wherein the image-recording material is selected from electrophotographic materials, heat-sensitive materials, inkjet-recording materials, sublimation transfer materials, silver salt photographic materials, and heat transfer materials.

16. The image-recording material according to claim 14, wherein the raw paper is made from a wet paper which is produced by subjecting to a press dry treatment.

17. The image-recording material according to claim 14, wherein the polymer-containing layer comprises any one of a water-soluble polymer and a water-dispersible polymer emulsion.

18. The image-recording material according to claim 14, wherein the polymer-containing layer comprises a pigment.
